(19) United States
(12) Patent Application Publication
(10) Pub. No.: US 2023/0283861 A1
(43) Pub. Date: Sep. 7, 2023

(54) NFT-Centric Video Player

(71) Applicant: Angel Studios, Inc., Provo, UT (US)

(72) Inventors: Seth Taylor, Provo, UT (US); Ajay Madhok, Provo, UT (US); Nick Graves, Provo, UT (US)

(21) Appl. No.: 18/112,492

(22) Filed: Feb. 21, 2023

Related U.S. Application Data
(60) Provisional application No. 63/312,311, filed on Feb. 21, 2022.
(60) Provisional application No. 63/312,280, filed on Feb. 21, 2022.

(51) Int. Cl. H04N 21/84; G06V 40/20; H04N 21/854; G06F 16/45

(52) U.S. Cl. CPC H04N 21/84; G06V 40/20; H04N 21/854; G06F 16/45

(57) ABSTRACT

A video player may comprise features for interacting with content in a manner that conveys to a viewer/consumer information about the relationship between an NFT and the content, and additionally provides an interface for the user/viewer to exploit, utilize, and/or engage. Content interface may identify portions of the content with an elevated status, rarity, and desirability. An NFT may be purchased and/or sold through the content interface. NFTs may be tracked in an off-blockchain registry and conventional blockchain may be used as a secondary register. The blockchain may be used for a universal access control list. The content may be tagged with an association between content and an idea. Content tagging may be independently searchable. Content interface may have segment-sensitive threading that updates as content progresses. An interface may present a textual or graphic representation of a user's impact on the community.

### BACKGROUND OF THE INVENTION

NFT's have come to represent/reference many different types of content: literary works, musical works, dramatic works, visual works, sound recordings, audiovisual works, combinations of such, and others.

An NFT may reference/represent an excerpt from an audiovisual work such as a scene, frame, or any other type of excerpt. Under the ERC-721 standard (or similar or analogous standards, technologies, or approaches), an NFT may reference off-blockchain content (e.g., an excerpt from an audiovisual work) as a hash by including, e.g., an IPFS (InterPlanetary File System) hash (for IPFS, referred to as a “Content ID” or “CID”).

Although an NFT may be associated with audiovisual content through the NFT's function as referencing/representing an excerpt from the audiovisual work, it can be unclear exactly how the NFT is related to the audiovisual work and what the meaning and/or use of that relationship is. What is needed is an improved system and method for viewing, consuming, and/or interacting with audiovisual content in a manner that conveys to a viewer/consumer information about the relationship between the NFT and the audiovisual content, conveys to a viewer/consumer information about the meaning and potential uses of the relationship between the NFT and audiovisual content, and additionally provides an interface for the user/viewer to exploit, utilize, and/or engage with the meaning and potential uses of the relationship between the NFT and audiovisual content.

### BRIEF SUMMARY OF THE INVENTION

The improved system and method for viewing, consuming, and/or interacting with audiovisual content disclosed herein may convey to a viewer/consumer information about the relationship between the NFT and the audiovisual content and additionally may provide an interface for the user/viewer to exploit, utilize, and/or engage.

A video player may have many features and functions such as displaying a “golden scene,” a playback marker, and a transaction history interface. A “golden scene” is a scene that has been identified by the content creator and/or users/viewers. These scenes may be scenes which have elevated importance or identified as a “fan favorite.” Not all fan favorite scenes may achieve “golden” status; some scenes may acquire silver or bronze status instead. A “golden scene” may be visually identified within the video player. For example, the scene may appear gold in color along the progress bar. In some cases, NFTs may be frames derived from the “golden scenes.” The transaction history interface may show NFT frame thumbnails, the NFT transferor/sellers, the NFT transferee/buyers, and brief transaction summary such as purchase price.

The video player interface may have an element that conveys information about NFTs. The interface may offer advance control selections for user selection and discovery of NTs. The interface may include information about the current NFT owner and provide users with an option to buy or offer to buy the NFT from the current owner. Information provided about the NFT may include the “rarity” of an NFT that may be used in whole or in part to value an NFT or to guide a potential seller and/or potential purchaser in determining a sale/purchase price. Rarity may be asset, transactional, semantic, owner-imposed, use, and/or any combination thereof.

A user that owns an NFT for a scene may become a community curator for the scene they own. The NFT owner may become a featured owner for other viewers and the NFT owner may identify comments or user content to be featured with the NFT scene. NFT ownership may be tracked in an off-blockchain registry and/or transaction register, and a conventional blockchain may be used as a secondary transaction register. Having the conventional blockchain as a secondary root of trust may facilitate blockchain agnosticism, i.e., a transaction history/provenance may be moved from a first blockchain to a second blockchain by simply storing a reference in the second blockchain to the transaction history/provenance in the first blockchain, and noting in the off-blockchain registry that the blockchain history/provenance has moved from the first blockchain to the second blockchain.

A blockchain may be used for a universal access control list. Using a blockchain-based universal access control list, multiple streaming providers may be able to authoritatively verify the user's rights for digital content.

The media player interface may include tagging. Tagging may comprise traditional metadata tags, user-generated tags, or other tags. Users may create and rank tag information used for searching. An NFT may be searched for not only by the title or owner but by the tags of the scene. Tags may include the sentiment of a scene, locations, references, and many more characteristics. Users may search videos and NFTs through tags or by other metrics. For example, a user wishing to see the most viewed videos may generate a search for “videos with over 1 million views.”

A media player may comprise an interface for segment-sensitive threading. In segment-centric threading the comments are specific to a segment of the content and may change as playback of content progresses forward, or is reversed. The threads may be segment/scene specific and/or semantic specific. For example, comments may be separated by the discussion topic, e.g., a first thread is MUSIC and a second thread is WARDROBE/MAKEUP. The first thread and second thread may be shown for a first scene and the first and second threads will change/update when a second scene starts.

A media player may present a textual or graphical representation of the impact that a user's donation/contribution/participation has had on others. This impact may arise through a variety of factors, e.g., financial donation/support, comments, curating, community activities, user-generated content, etc.

### BRIEF DESCRIPTION OF THE DRAWINGS

FIG. 1 illustrates an exemplary NFT-Centric Content Player.

FIG. 2 illustrates an exemplary NFT-Centric Content Player where the user has selected a particular NFT owner.

FIG. 3 illustrates an exemplary NFT owner's community moderator page.

FIG. 4 illustrates an exemplary content player with a featured NFT owner.

FIG. 5 illustrates an exemplary world-wide user impact map.

FIG. 6 illustrates an exemplary user impact map in a tree format.

FIG. 7 illustrates an exemplary content interface for user scene ratings and user interactions.

FIG. 8 illustrates an exemplary content interface for user scene ratings as the media credits roll.

FIG. 9 illustrates an exemplary timeline of NFTs for a video.

FIG. 10 illustrates an exemplary search interface with common search requests.

FIG. 11 illustrates an exemplary NFT-Centric Content Player.

FIG. 12 illustrates an exemplary NFT seller platform.

FIG. 13 illustrates an exemplary diagram of the user's NFT wallet and corresponding devices and servers.

FIGS. 14A-D illustrate an exemplary content player featuring comment threading and/or semantic tagging.

FIG. 15 illustrates an exemplary content player with content tags.

FIG. 16 illustrates an exemplary tag search by a user.

FIG. 17 illustrates an exemplary content player including benefactor information to the viewer.

FIG. 18 illustrates an exemplary diagram of an Access Control List.

FIG. 19 illustrates an exemplary content player including an interface for discovering additional NF's.

FIG. 20 illustrates an exemplary content player displaying common rarity metrics.

FIGS. 21A-B illustrate an exemplary content player including interfaces for scene-centric threading.

FIG. 22 shows a flowchart for an exemplary method for semantic tagging.

### DETAILED DESCRIPTION OF THE INVENTION

This application claims priority to U.S. Provisional Application No. 63/312,311, titled “NFT Viewer,” and filed on Feb. 21, 2022; and additionally to U.S. Provisional Application No. 63/312,280, titled “NFT-Centric Video Player,” and filed on Feb. 21, 2022, both of which are incorporated herein by reference in their entireties.

Systems and methods are described herein below for viewing, consuming, and interacting with content associated with NFTs. Also disclosed herein are systems and methods for viewing, consuming, and interacting with content that may not be associated with NFTs.

### TABLE OF REFERENCE NUMBERS FROM DRAWINGS

The following table is for convenience only and should not be construed to supersede any potentially inconsistent disclosure herein.

| Reference | |
|---|---|
| Number | Description |
| 100 | content viewing/consumption interface (aka Video Player) |
| 101 | audiovisual content |
| 102 | play/pause control |
| 104 | advance/ reverse control |
| 105 | “golden scene” |
| 106 | playback marker |
| 107 | benefactor/impact interface element |
| 110 | compact ownership visualization |
| 115 | NFT map |
| 120 | NFT info interface element |
| 122 | offer control |
| 125 | transaction history interface element |
| 126a-n | transaction summaries |
| 127a-n | frame thumbnail |
| 128a-n | NFT transferor/seller |
| 129a-n | NFT transferee/buyer |
| 130a-n | NFT sale price |
| 140a-n | audiovisual segments |
| 141a-n | segment comment thread |
| 142a-n | semantic segment thread |
| 150 | NFT |
| 151 | frame |
| 160 | NFT owner |
| 161 | additional featured NFT owners interface |
| 162a-n | NFT owners a-n |
| 163 | NFT owner visual identifier interface element |
| 170 | audiovisual progress bar |
| 171 | beginning of content |
| 172 | end of content |
| 180a-n | tag types |
| 181a-n | tag ratings (0-100) |
| 182 | user input for tags |
| 190 | NFT interface—view additional collectibles |
| 191a-n | additional NFTs |
| 200 | offer interface |
| 201 | NFT metadata/tag information |
| 300 | seller-side offer interface |
| 322 | offer acceptance control |
| 325 | offer history interface element |
| 400 | NFT portability |
| 401a-n | blockchain servers |
| 410 | primary root of trust |
| 411a-n | user wallets |
| 420a-n | end-user device |
| 421a-n | alternative end-user device |
| 500 | community ownership interface |
| 501 | NFT scene title |
| 502 | community notification/activity element |
| 503 | audiovisual viewer comment element |
| 504 | comment element indicating preference |
| 510a-n | audiovisual viewer icon/profiles |
| 600 | golden scene interface |
| 601 | golden scene rating element |
| 602 | viewer interface element for creating content |
| 603 2 | audiovisual credits scene |
| 604 | multi-scene rating interface element |
| 700 | search interface |
| 701 | search bar |
| 720 | search terms |
| 721a-n | recommended search terms |
| 800 | access control list |
| 801 | NFT platform 1 |
| 802 | NFT platform 2 |
| 900 | graphical representation of benefactor data |
| 901a-n | benefactor impact to a location |
| 950 | tree representation of benefactor data |
| 951 | first level pay-it-forward donor |
| 952a-n | second level pay-it-forward donor(s) |
| 953a-n | thirds level pay-it-forward donor(s) |
| 1010 | NFT rarity metrics interface |
| 1020a-n | types of NFT rarity metrics |
| 2200 | flow chart for semantic threading |
| 2210 | step in flow chart 2200 |
| 2220 | step in flow chart 2200 |
| 2230 | step in flow chart 2200 |
| 2240 | step in flow chart 2200 |
| 2250 | step in flow chart 2200 |

NFT-Centric Content Player

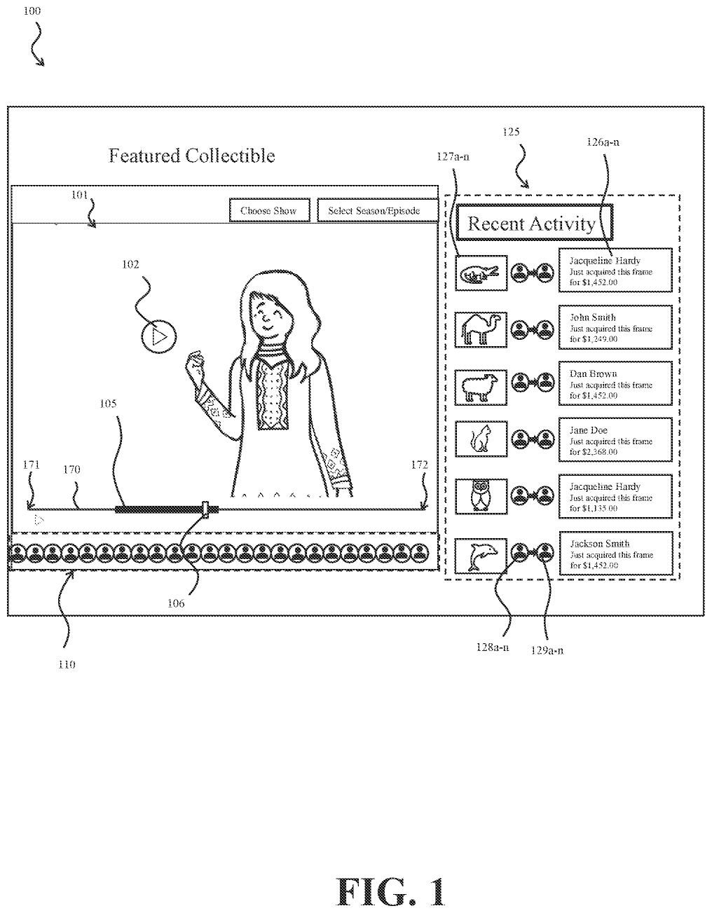

FIG. 1 shows an exemplary NFT-Centric Content Player, which may also be referenced herein below as a “Content Player” or “Video Player.” “Content”, as used herein may be audio only, video only, audiovisual, or any other type of content known in the art. The disclosure herein below will focus on a player for audiovisual content, which may be referred to as “video” content. But the disclosures herein may be applied directly or by analogy to players for consumption of other types of content.

In one embodiment, a Video Player 100 may comprise the exemplary interface shown in FIG. 1, which shows the content in a paused state. Interface element 102 may be a play/pause control that toggles between “play” and “pause” symbols. The “play” symbol 102 may indicate that viewer 100 is in a pause state and that selecting the “play” interface element will return viewer 100 to a “play” state. The Video Player 100 may further comprise a visual representation identifying a “golden scene” 105, a playback marker 106, and the recent transaction history interface element 125. The transaction history interface 125 may show the frame thumbnails 127a-f, the NFT transferor/sellers 128a-f, the NFT transferee/buyers 129a-f, and brief transaction summaries 126a-f. Interface element 110 may be a compact ownership visualization showing a representation of some or all users who own or have an ownership interest in NFT 150.

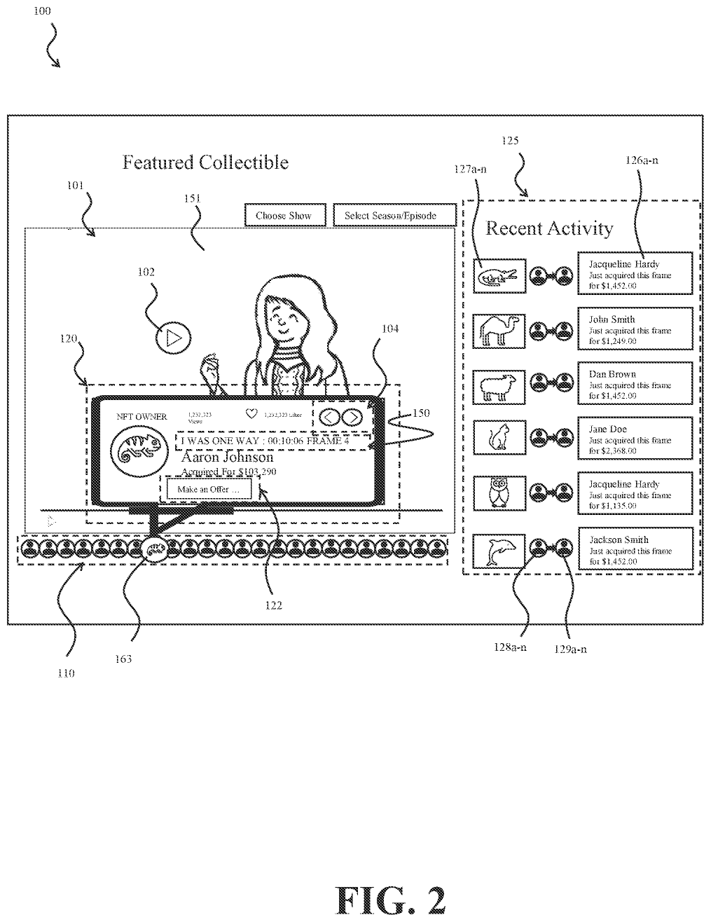

As shown in FIG. 2, NFT info interface element 120 may be an interface element for conveying information about an NFT 150. NFT info interface element 120 may contain interface features such as advance or reverse control selection 104 or a purchase offer 121. As shown in FIG. 2, NFT 150 may represent an ownership interest in and/or other relationship to frame 151, which is the frame at time 00:10:06 frame 4, of paused audiovisual content 101 being presented by viewer 100. In one embodiment, when the viewer selects an NFT 150 within interface element 110, information about the NFT 150 and the NFT owner's profile 163 become visible for the viewer.

Many schemes have been used and/or are available to memorialize an NFT interest in content, e.g., a frame from audiovisual content. For example, blockchain may be used to memorialize ownership of the NFT and the content rights associated with the NFT. The NFT may reference/represent an ownership interest in a frame from audiovisual content. NFT ownership may be memorialized/recorded on a blockchain such as Ethereum. The actual image file of the associated frame may be stored in a storage platform such as IPFS (Inter Planetary File System), and the IPFS CID (IPFS Content Identifier) may be stored in the NFT on the Ethereum blockchain. Although this disclosure specifically references IPFS and Ethereum, many other analogous technologies and/or platforms may be used.

Although many frame rates may be used for video content, one standard frame rate is 24 frames per second (fps). The discussion herein will assume 24 frames per second for the sake of illustration.

Interface element 120 may comprise information about NFT 150 and additionally about one or more owners 163 of NFT 150. For example, as shown in FIG. 2, interface element 120 indicates that NFT 150 references/represents an ownership interest in frame 151 titled/named “I WAS ONE WAY,” which occurs at time 00:10:06 frame 4 of audiovisual content 101.

In one embodiment, the ownership interest for frame 151 is for a particular and specific frame occurring at time 00:10:06 frame 4 of the audiovisual content.

In one embodiment of an exemplary method, a NFT ownership information database may store information about NFT ownership as described herein. Video Player 100 may determine to present/play content. In conjunction with presenting/playing the content, Video Player 100 may present NFT ownership information associated with the content.

Community Scene Ownership

In addition to the interest in the specific frame at 00:10:06 frame 4, the NFT owner may have an additional interest in the scene of which it is a part. This embodiment creates a small community/group of owners for a particular scene. One benefit of this embodiment is the NFT owner is not strictly limited to a particular frame, but has an association with the contextual scene.

For example, in live-action audiovisual works many frames within a scene would by themselves appear to be blurry, or may capture a less-appealing facial expression of a character. While the NFT owner has a particular and special interest in a particular frame, the ownership may have special rights relative to the scene, e.g., the option for the owner to access the entire scene or display the best image from a scene. Having an association/relationship with the entire scene provides a connection to overall desirable content (e.g., the entire scene) instead a frame that may capture an awkward or blurry moment of the scene.

In another similar embodiment, NFT ownership may provide access to the entire scene, but the NFT owner may be limited to publishing or otherwise using only their particular frame rather than any frame within the scene. This embodiment may be more useful for animated audiovisual work. Unlike live-action works, in animation the majority of available frames in animations are clear and usable images. Animation works by creating an optical illusion. A viewer sees many still images in quick succession and the viewer is able to interpret the images as a continuous moving image. Because animation may have few-to-no frames which would be considered less-desirable images, the NFT owner may need to have permission to publish only their frame but may also receive rights to otherwise access/use the scene as a whole.

As shown in FIG. 2, NFT interface element 120 may additionally include information, interface elements, and controls related to an NFT 150 associated with identified frame 151. For example, as shown in FIG. 2, a user/viewer identified as “Aaron Johnson” may own NFT 150. NFT interface element 120 may additionally comprise NFT owner visual identifier interface element 163, which may be a visual representation of, or image associated with, an/the owner of NFT 150.

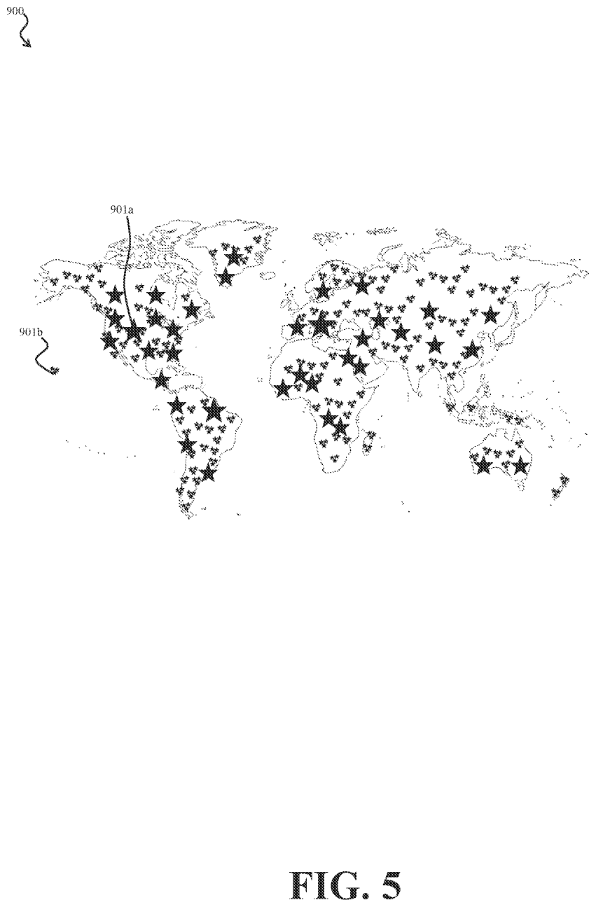

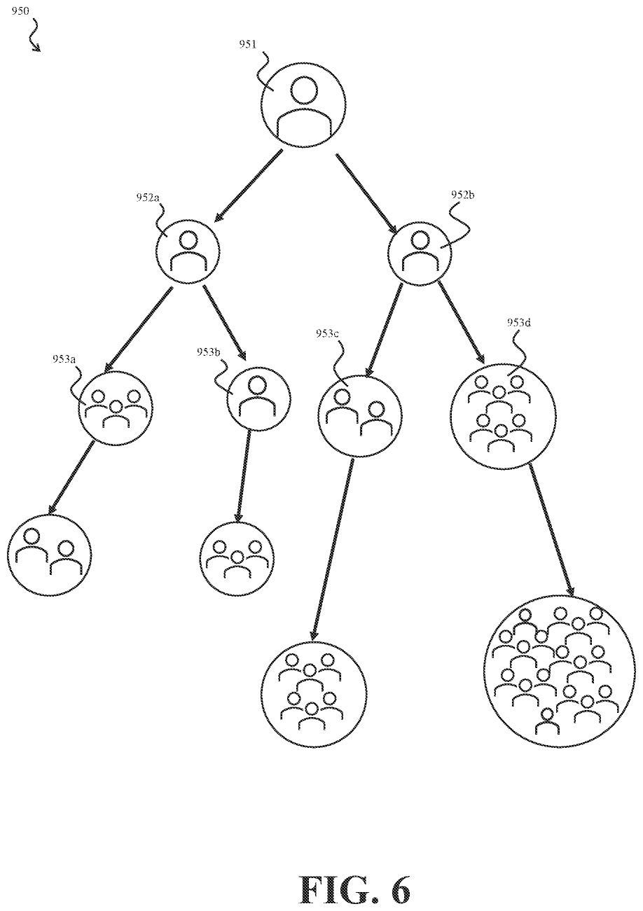

In one embodiment, NFT interface element 120 may comprise various metrics or metadata about the NFT or the NFT owner. For example, interface element 120 may present information, e.g., a graphical representation, of the popularity of a scene. Scene popularity may be measured and/or visualized by number of shares, number of views, number of comments, number of viewers who have favorited/liked/marked the scene, NFT ownership density (e.g., number of owned frames divided by total number of frames, possibly normalized by scene length). Alternatively, interface element 120 may also include information about a particular NFT owner, e.g. content recommended by the NFT owner, other NFTs owned by this owner, shows recently watched by the NFT owner, the number of individuals impacted by pay-it-forwards or other donations/contributions from the owner, an impact map/visualization (see FIGS. 5-6), and/or owner status. Status metrics may reflect the earliness (how early) at which the owner invested in, supported, consumed, or otherwise promoted the content. For example, earlier donation/support may give “hipster” status to the owner, and later donation/support may be less venerable.

In another embodiment, metrics and/or metadata may be user-specific. The information shown may be based on the user's profile rather than the NFT owners. In one example, the metrics may be relative to others in the user's geographic region. The interface may display only the NFT owners in the area. Alternatively, the metrics may be based on the number of shares for people in the region or shows recommended within the region. The metrics displayed on the interface may be based on a variety of sources such as geographic region, associated friends and family, demographics of the user, and user interests.

In another embodiment, presented metadata may include shows, awards, and/or status of the frame owner. For example, the owner may have a green star near or otherwise associated with their name and/or profile representation. The green star may indicate that the owner is the original owner of the frame. Alternatively, a red heart after the user's name may denote that the owner has impacted over one million people since becoming a member of the community. There are many visual identifiers that may be used to denote various statuses, badges, accomplishments, and/or rewards for both the owner of the NFT and the viewers interacting on the platform.

Community Ownership Rights and Interests

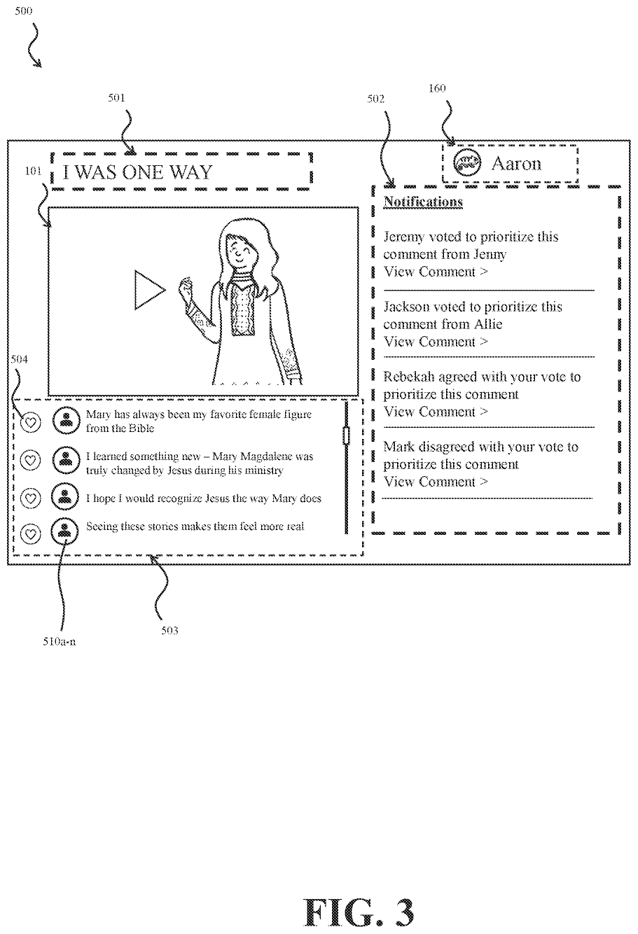

In some embodiments, the NFT owner may have a special interest in a particular frame 151 as well as an additional interest in the entire scene that frame 151 is a part of. This embodiment creates a small community of owners for a particular scene. This communal ownership may have additional and/or unique rights. For example, the community of NFT owners for a scene called “I WAS ONE WAY” 501 may have the right to moderate/curate comments 503 about scene 501. The owners may have the right, and an associated interface, for reviewing comments from other viewers to rank for relevance and/or impact. Viewer comments selected by the NFT owners may become featured or prominent comments for the scene. In one embodiment, as shown in FIG. 3, Video Player 100 may present a community ownership interface 500 based on the ownership status/rights of NFT owner 160. Community ownership interface 500 may include a notification or activity element 502 to inform owner 160 of other community owner interactions with the interface 500. The interface 500 may further comprise a comment section 503 that may include comments from various viewers 510a-n. Comment section interface element 503 may include an interface element 504 configured to receive input from owner 160 regarding identification of comments owner 160 may have found to be important, relevant, or impactful to other community owners.

Featured Ownership

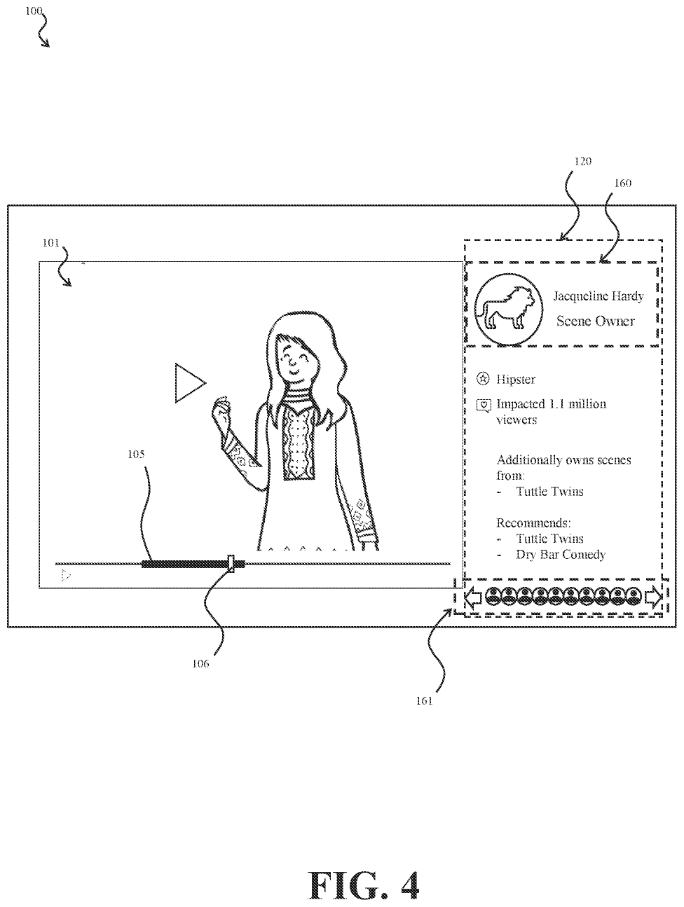

As shown in FIG. 4, in one embodiment Video Player 100 may include an interface element 120 for displaying information about users/viewers who have an association with a scene or other content that is being currently viewed in Video Player 100 (or that has been recently viewed or that will shortly be viewed). This association may be super-user or privileged user status; ownership of an NFT representing an association with a frame, the scene, or similar content; or any other noteworthy association. In one embodiment, the association may be ownership of an NFT representing ownership (or some other relationship) of a frame (or other content) from the scene. Video Player 100 may show interface element 120 when content playback is paused or when content playback is ongoing. FIG. 4 shows an exemplary embodiment in which Video Player 100 displays interface element 120 when content playback is paused.

As shown in FIG. 4, in one exemplary embodiment interface element 120 may feature one or more NFT owners. FIG. 4 shows an embodiment in which interface element 120 features NFT owner profile 160. Video Player 100 may select featured profile 160 based in whole or in part on one or more of the following factors: financial contribution/support to the content or to related content; timeliness of such financial contributions (e.g., earlier contributions/support may be given greater weight than later contributions); activity relating to the content (e.g., sharing, likes, user-contributed content, number of views, curation/critiquing efforts for the content or for comments or user-generated content of other users related to the content); NFT ownership for NFTs related to or representing an interest in the frame, scene, or other content that is temporally proximate to the moment at which the content is paused; feedback/curation of other users regarding the value of the featured user's/viewer's activity related to the content; geographic proximity to other users (e.g., geographic proximity of a user to the user/viewer consuming content in Video Player 100 may affect the likelihood of that user's profile being selected as a featured profile); social distance (e.g., a social proximity of a user to the user/viewer consuming content in Video Player 100 such as social media friends or connections or relationship chains, other known relationships or relationship chains may affect the likelihood of that user's profile being selected as a featured profile): similar demographics (e.g., similar demographics between a featured user and the user/viewer consuming content in Video Player 100 may affect the likelihood of a user's profile being selected as a featured profile); and/or similar viewing habits or viewing history (e.g., similar viewing habits or viewing history between a user and the user/viewer consuming content in Video Player 100 may affect the likelihood of that user's profile being selected as a featured profile)).

In one embodiment, as shown in FIG. 4, multiple featured profiles may be displayed in profile interface 161, and/or profile interface 161 may present interface elements for accessing/viewing additional featured profiles, e.g., by scrolling. View/access arrangement or order (multiple views may be presented in a spatially one-dimensional view, e.g., a scrolling interface, or in a spatially two-dimensional view, e.g., an interface showing the most featured profile(s) at the center and decreasing-relatedness profiles further from the center profile, or otherwise) may be based in whole or in part on the factors described above for selecting a featured profile.

Information presented about a featured profile 160 in interface 120 may include but is not limited to name, username, and/or any of the information described above for determining featured status or level of featured-ness.

Significant Scenes

Some scenes may have special significance. In one embodiment, as shown if FIGS. 1, 4, 7, 15, and 17, a scene that is especially significant may be referred to as a “golden scene” 105 (other terminology may be used, of course). For example, a scene that evokes a particularly strong emotion of hope may be characterized as a “golden scene.” One exemplary characterization scheme may include golden scenes, silver scenes, bronze scenes, etc. Other characterization schemes may include a rating and/or ranking system.

As shown in FIG. 1, Video Player 100 may include an audiovisual progress bar 170 that provides a visual and/or textual representation to a viewer of the current content play point 106 relative to the beginning 171 and/or end of content 172. Current play point 106 may be shown along a timeline 170.

In one embodiment, timeline 170 may include a visual representation of a significant scene such as a golden scene 105. As shown in FIG. 1, golden scene marker 105 may be a thicker line/bar, or a line/bar having a distinctive color/design, or another graphical representation showing the beginning, middle, duration, and/or end of the golden scene.

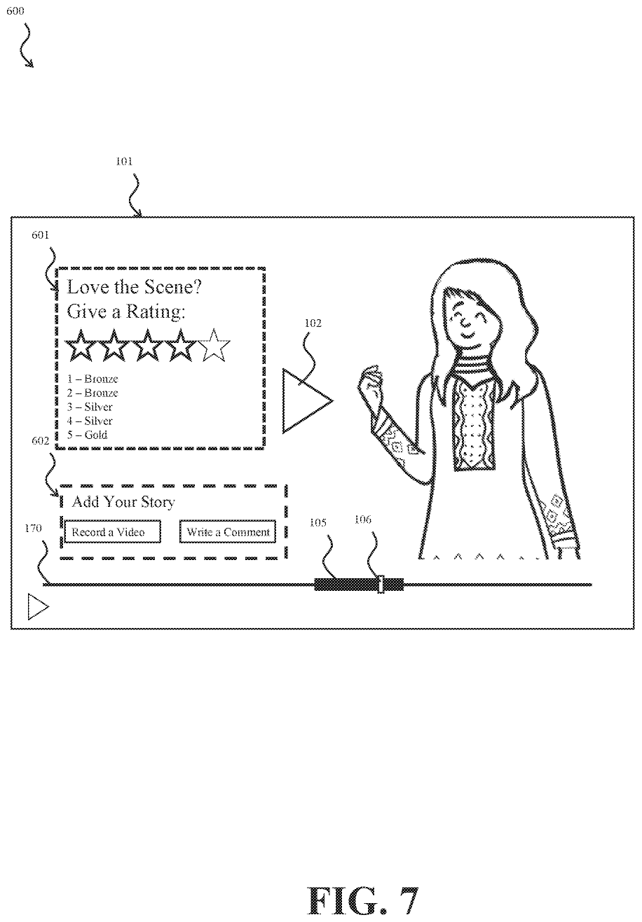

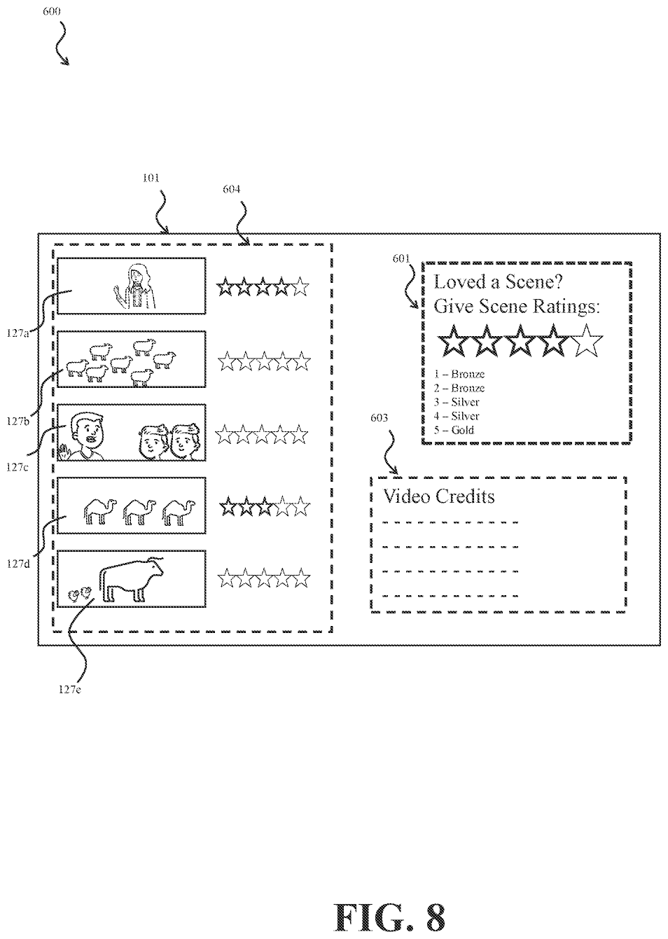

A golden scene 105 (or other type of significant scene) may be identified in multiple ways. In one embodiment, Video Player 100 may receive input from viewers regarding the significance of a scene. For example, in conjunction with playing a scene, Video Player 100 may elicit input from a viewer through an interface element 601 that elicits input with a question such as, “Should this be a golden scene”? In another embodiment, Video Player 100 may comprise an interface element to receive an indication from a user, e.g., an administrator, user, or privileged user, that a scene is a “golden scene.” In another embodiment, as shown in FIG. 7, Video Player 100 may present a prompt 601 to rate a scene while in a paused state. In a similar exemplary embodiment, as shown in FIG. 8, Video Player 100 may present a prompt rate multiple scenes 127a-e through interface element 604 at the same time after the video has completed and the video credits 603 are rolling, and Video Player 100 may receive such input. In these embodiments, Video Player 100 may determine golden scenes 105 based on user/viewer ratings. In another embodiment, Video Player 100 may determine to characterize a scene as a “golden scene” based on factors such as NFT ownership, views, comments, user feedback, user-generated content for the scene, etc. For example, if a scene (or a segment of a scene) has a significant number of views, replays, or pauses, then Video Player 100 may determine that the scene is a “golden scene.” Another factor may be user interaction activity, e.g., number of shares, comments, likes, requests to purchase NFTs associated with the scene, NFT transaction activity associated with the scene, etc.

In another embodiment, Video Player 100 (or another interface) may present an interface for receiving information super-users and/or privileged users identification/curation of golden scenes. A super-user may be a user that has additional privileges based on some or all of the following factors: financial contribution to content (amount, timing, etc.); amount of content viewed/consumed; regularity of content viewing/consumption; support through sharing, commenting, generating and/or providing user content, etc.; NFT ownership for frames and/or content related to the scene.

In one embodiment of an exemplary method, Video Player 100 may identify a scene that is part of video content. Video Player 100 may characterize the scene, e.g., with a tag, information, or a characterization as, e.g., a “golden” scene. In conjunction with presenting/playing the content, Video Player 100 may present a representation, e.g., a visual representation, of the scene beginning, end, and/or duration relative to a chronological representation of the content.

Offer/Purchase/Bid/Acquire Interface

NFT interface element 120 may additionally include interface elements related to purchasing/acquiring NFT 150. For example, as shown in FIG. 2, NFT interface element 120 may include offer control 122. Based on receipt of interaction with offer control 122, Video Player 100 may present interface 200, which may comprise interface elements allowing the user to purchase, bid on, or offer to purchase NFT 150. Additionally, Video Player 100 may present a transaction history 125 for NFT 150. In general, Video Player 100 may present any information that may assist a user in determining the value of NFT 150, information about NFT 150, or any other information relating to a purchase or potential purchase of NFT 150.

As shown in FIGS. 1 and 2, interface element 110 may be a compact ownership visualization showing a representation of some or all users who own or have an ownership interest in NFT 150.

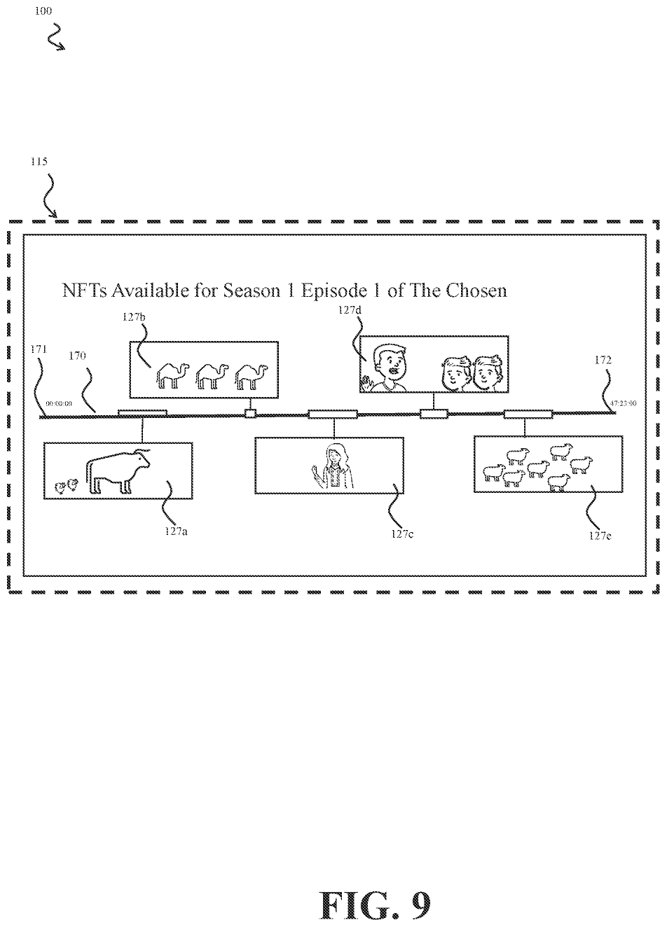

As shown in FIG. 9, Video Player 100 (or another interface) may present interface element 115, which may be referred to as an NFT map 115. This may present a visualization of the chronological locations of NFTs in audiovisual content 101. Element 115 may be presented on an interface screen alone or it may be a smaller portion of a larger interface. In FIG. 9, NFT Map 115 is presented as if it were to appear on the interface screen alone. In some embodiments every frame or a significant portion of the frames may be associated with an NFT and/or available for association with an NFT. In other embodiments, NFTs may be associated with only a relatively small portion of the total frames. Often this will be the frames that are noteworthy for some reason, e.g., for emotional, sentimental, action, drama, visual, auditory, or other noteworthy feature(s) or characteristic(s).

In one embodiment, interface element 115 may comprise a temporal zoom control, e.g., a timeline showing a time-expansion visualization of the locations on the timeline of frames associated with NFTs and/or available for association with NFTs. Other interface visualizations may be used to convey to a user/viewer information about the temporal (or spatial or other dimensions) locations/density of frames or other excerpts from audiovisual content that are associated with NFT's, owned, and/or available for association with NFTs.

As shown in FIG. 2, advance/reverse control 104 may allow a consumer/viewer to advance or go back to the next/previous NFT.

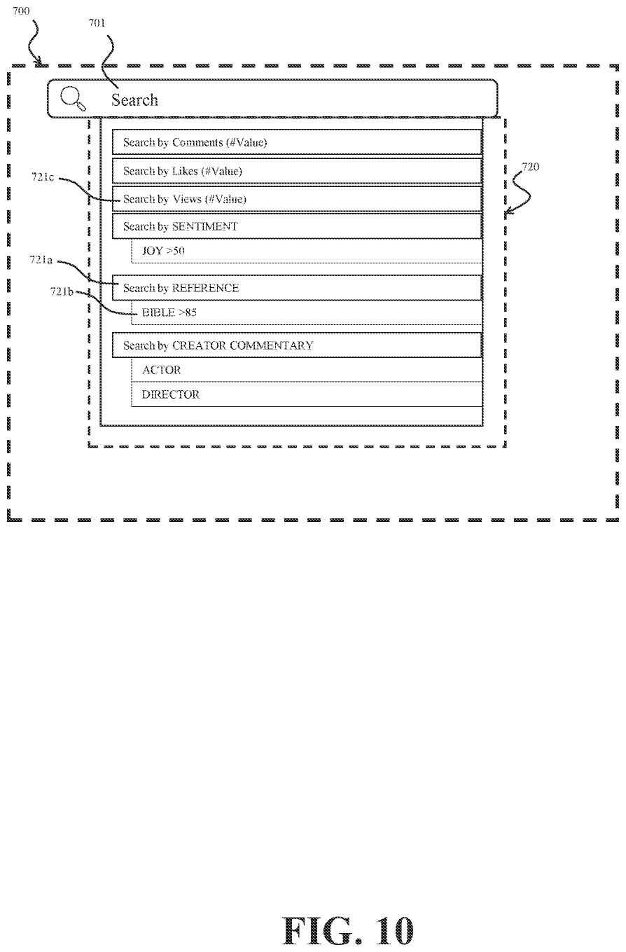

The searching and browsing of NFTs is not limited to a temporal view. The consumer/viewer may be able to browse NFTs based off the image or associated images. Browsing may be linked to a heat map which shows the density of views, comments, likes, and/or audio of a particular NFT. Another method may be based on a subject matter map, e.g., dramatic moments, punchlines, music genre, specific characters/actors, specific background, scene setting, and/or filming locations. These browsing and searching methods create browsable, sortable, and identifiable N I's inside the player as well as in an outside marketplace. In one embodiment, as shown in FIG. 10, search option 701 may provide a drop-down list of common or recommended search terms 720 to the user. In one embodiment, search terms 721a-n may be for audiovisual metadata or tags. An exemplary search would be for a Bible story such as Noah's Ark. For this search, a user could start with a REFERENCE search 721a where “BIBLE” 721b has a tag score greater than 85. The results would only include content with a BIBLE REFERENCE score between 86 and 100. In another search, the user may want to see only videos which have been viewed over 2 million times. The search would be “Search by Views (>2 million)” 721c.

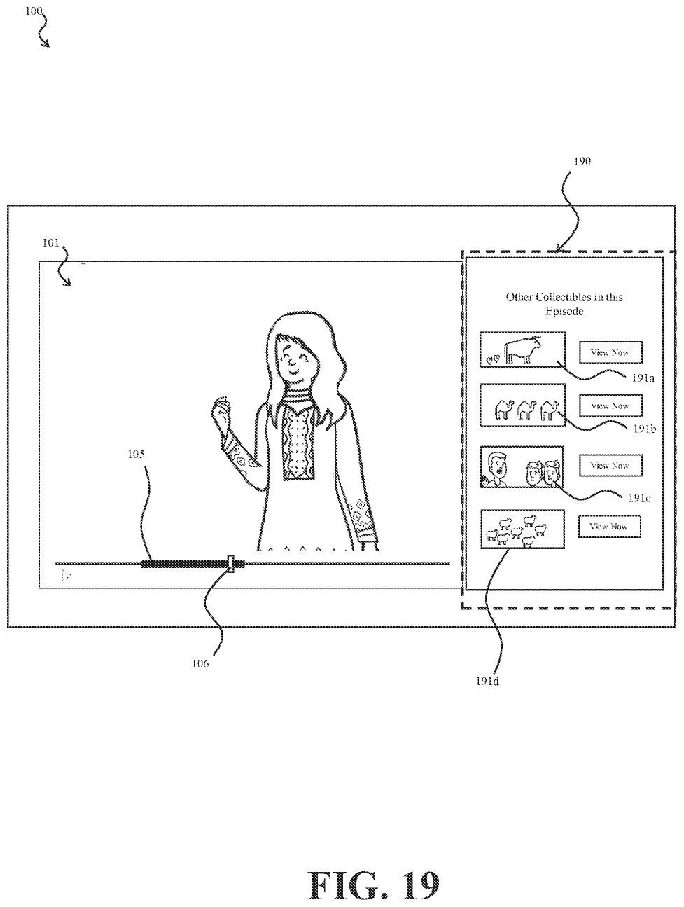

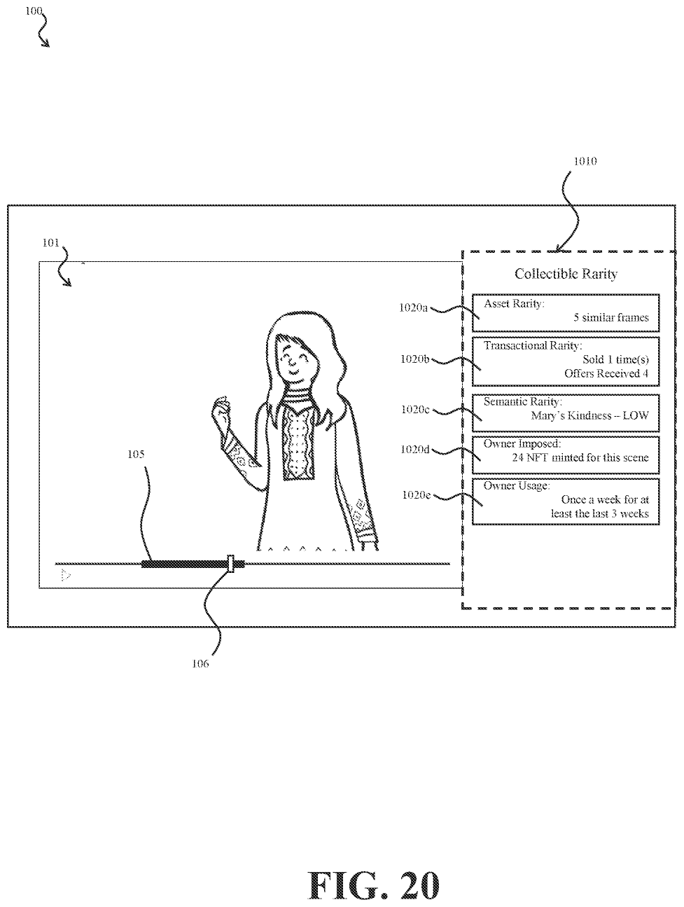

In one embodiment, as shown in FIG. 19, Video Player 100 may provide an interface 190 for discovery of NFTs 191a-n without pausing. For example, a sidebar interface 190 may provide information about upcoming NFTs, or recently passed NFTs, or current NFTs. In another embodiment, the NFTs may be discoverable through internal and/or outside marketplaces; these examples include packs, promotions, profile pages, vaults, and public displays.

As shown in FIGS. 1, and 2, transaction history interface element 125 may comprise a visualization 125 of recent NFT transactions relating to some universe of audiovisual content. For example, as shown in FIG. 1, transaction history interface element 125 may present information about recent NFT transactions for NFTs associated with frames (or other content excerpts) from audiovisual content 101. Transaction summaries 126a-n may present information about a single transaction (or possibly a group of related transactions). For example, as shown in FIGS. 1 and 2, transaction summary 126a may indicate that the NFT associated with the frame represented as thumbnail 127a was purchased by user 129a from user 128a for NFT sale price 130a. Transaction summary 126a may present other information or combination(s) of information (e.g., timestamp of transaction, bids/offers/counteroffers for transaction, etc.). In some embodiments, when a user selects or otherwise interacts with transaction summary 126a, additional information about the transaction may be presented to the user.

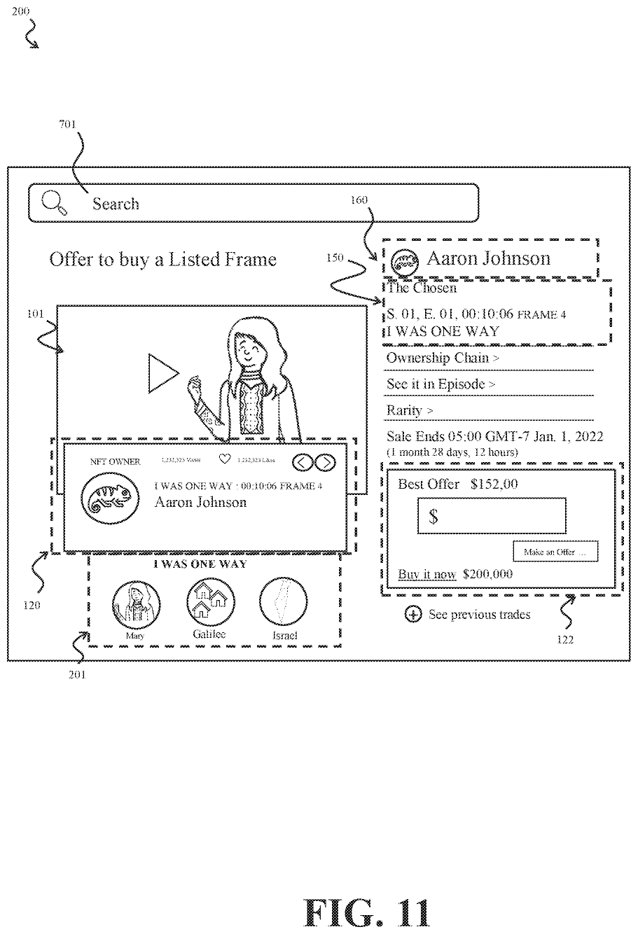

As shown in FIG. 2, when a user selects offer control 122, or otherwise interacts with offer control 122, or upon another trigger or reason, Video Player 100 may present offer interface 200, as shown in FIG. 11. FIG. 2 shows an exemplary offer control 122. As shown in FIG. 2, offer control 122 may include interface elements for presenting information and context about an NFL, for allowing the user to bid on an NFT, or to offer to purchase an NFT, or to communicate with the owner of the NFT, e.g., to inquire as to the owner's interest in selling the NFT, or to inquire about the availability or ownership of similar NFTs. As shown in FIG. 11, offer interface 200 may present information about the NFT (e.g., owner name 160 (“Aaron Johnson”), title of audiovisual content (“The Chosen”), frame/excerpt identification (“Season 1, Episode 01, 00:10:06 frame 4), NFT name (“I WAS ONE WAY”), ownership chain/provenance, rarity; and/or purchase information/availability (whether owner is currently interesting in selling, asking price, other bids, buy-it-now price, current best bid/offer, bid beginning, end, and other timing, messages/inquiries to NFT owner)). A potential purchaser may offer to purchase an NFT regardless of whether the NFT owner has listed the NFT for sale. Offer interface 200 may include element 201 showing metadata or tag information used for search element 700. Element 201 may show all relevant tags, the most popular search tags, and/or the highest ranking tags for the NFT.

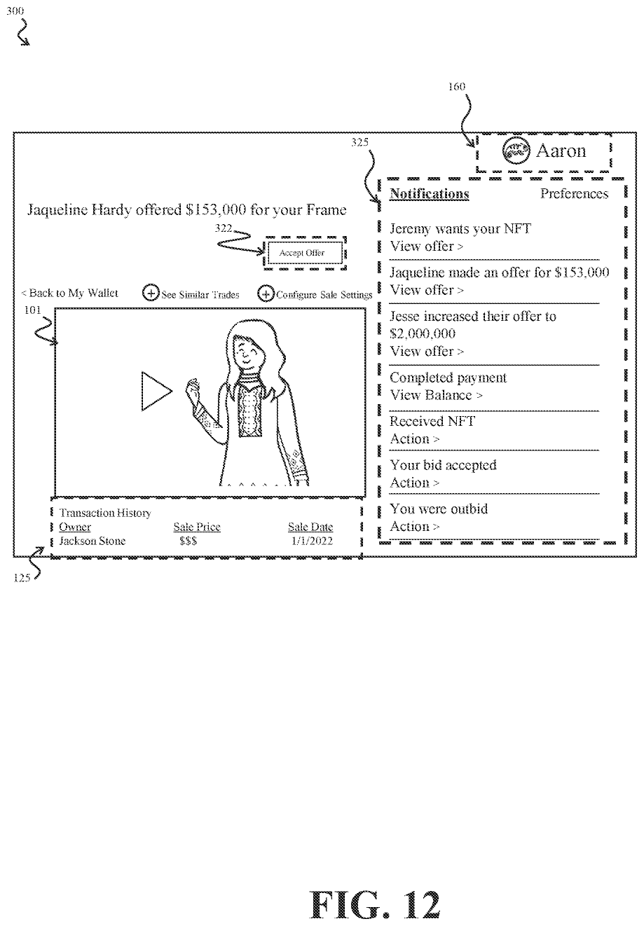

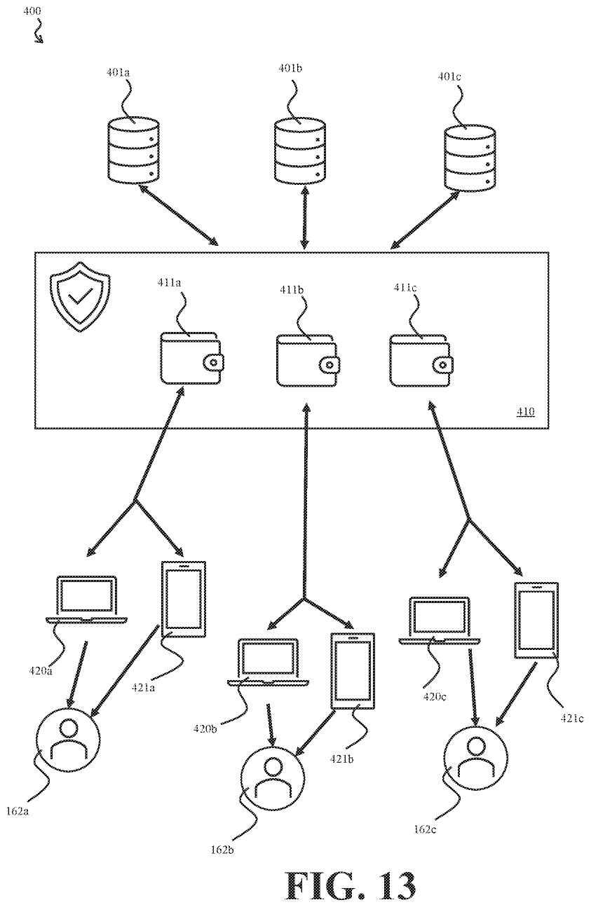

As shown in FIG. 12, seller-side offer interface 300 may be presented to the owner of an NFT for which a purchase offer has been made to notify the owner or to allow the owner to communicate with a potential buyer, to counteroffer, to modify auction/bidding parameters, and/or to do any other action that may be associated with selling an NFT. Seller-side offer interface 300 may include a transaction history interface element 125, an offer acceptance control 322, and/or an offer history interface element 325.

Blockchain Ownership Tracking

In one embodiment NFT ownership may be tracked in an off-blockchain registry and/or transaction register, and a conventional blockchain may be used as a secondary transaction register. For example, as shown in FIG. 13, a primary transaction register 410, which may be referred to as a primary root of trust, may be an off-blockchain transaction database where users 162a-n each have their own wallets 411a-n. Software and/or interfaces presented on a user 162a-n's personal devices 420a-n and/or 421a-n may present an interface for user 162n to view, access, and/or interact with user's wallet 411n within transaction system 410. The same system may periodically (may be realtime, may be non-realtime) write transactions to a blockchain that may serve as a backup transaction register on a blockchain server 401a-n, which may be referred to as a secondary root of trust. Using a conventional blockchain as a secondary root of trust instead of a primary root of trust may facilitate blockchain agnosticism, i.e., a transaction history/provenance may be moved from a first blockchain to a second blockchain by simply storing a reference in the second blockchain to the transaction history/provenance in the first blockchain, and noting in the off-blockchain registry that the blockchain history/provenance has moved from the first blockchain to the second blockchain. An exemplary system 400 is shown in FIG. 13. This system/structure may facilitate true blockchain agnosticism and/or NFT portability across blockchains.

Rarity

The concept of “rarity” may be information about an NFT that may be used in whole or in part to value an NFT or to guide a potential seller and/or potential purchaser in determining a sale/purchase price.

Rarity may be computed, disclosed, and used in multiple ways and for multiple purposes.

Although many notions of rarity may be used, the following five notions of rarity are described in detail herein: asset, transactional, semantic, owner-imposed, and use.

Asset (or computational) rarity for a frame may be computed or determined, in whole or in part, based on the number of frames that are similar to a particular frame. This determination/computation often turns on the number of frames in the same scene, context, moment, or micro-story, as well as on the frames-per-second rate of the associated audiovisual content. For example, if a scene comprises a ten-second kiss between two people who move only minimally during the scene and the camera characteristics (e.g., angle, zoom, position) change only minimally during the scene, and the scene has 24 frames per second, then all 240 frames (24 frames/second×10 seconds) may share high asset similarity, tending to make a single frame from the 10-second scene less rare because another 239 frames are significantly similar. The inverse is also true: a lower number of similar frames suggests greater rarity.

Transactional rarity is a rarity metric/heuristic based on the frequency with which a frame (i.e., the NFT(s) associated with or that represent/reflect an ownership interest in the frame) is associated with or is the subject of a transaction for a change of ownership (or change of similar/related/analogous rights). Such transactions may include but are not limited to a sale, an offer to sell, a request to purchase, a search for available NFTs, an auction, a bid, correspondence about potential sales, changes in asking price, changes in offer price, a decision to reject an offer to purchase, etc.

Semantic rarity (which may also be referred to herein as “essence rarity”) for a frame may be computed or determined, in whole or in part, based on the frequency with which one or more particular semantic/essence features occur over some universe of content. Semantic/essence features may comprise, e.g., a conspicuous/noteworthy item, a facial expression, a personal effect, clothing, an action, a color scheme, a background location, a word, a sound, a combination of characters, etc. For example, a frame showing Darth Vader innocently giggling at a cute joke (assuming it did happen at some point) would be semantically rare over the universe of content comprising all Star Wars movies, but a frame showing Darth Vader being stern and unsympathetic would be semantically unrare over the same universe of content. Or, in another example, a frame showing the man in the yellow hat (from Curious George) wearing a blue hat would be semantically rare over the universe of all Curious George movies and animations, but a frame showing the man in the yellow hat wearing a yellow hat would be semantically unrare over the same universe.

Another form of semantic rarity can be created by the value created by the content's creator. The creator can denote a purpose or reason behind the decisions of a particular scene. The semantic rarity may come from a content creator only disclosing the meaning behind one scene in an audiovisual work, e.g., the creator has made over 10 hours of a popular show but chooses to only discuss one 3-minute scene he found especially powerful when creating the work. The creator may choose to provide special behind-the-scenes commentary or content which is only accessible to the NFT owners. The content creator may include a prominent actor, the director, the writer(s), and/or an executive producer.

Another form of semantic rarity may be created by user influences such as polling, commenting, or by an algorithm using the number of views of a particular scene. Active viewers and participants in the audiovisual content may have a significant influence on a work. Many viewers may choose to interact with audiovisual works which have an impact or meaning on their lives. In general, the more individuals share the impact a work has had on their life, the greater more the semantic value of a may increases. For example, in the online show The Chosen many fans have expressed the impact the story of Jesus healing Mary (Season 1 Episode 1) has had on their life. The scene for Mary would have a high semantic value created by user comments.

Further, the semantic rarity can have different ranking values based upon user interactions. In one example, the rankings may be common, silver, gold, and/or platinum. In the user ranking system, the most impactful scenes will receive a higher ranking such as platinum, whereas an impactful but not as well-ranked scene may be rated silver. In the ranking system there may be few platinum scenes but many common scenes. There are many ways to determine impactful scenes. In one embodiment impact may be determined based on user interactions. Impact may also be based on a scene's association with “pay it forward” donations. The ranking system may be used across a series or across all the host's audiovisual content platform. Returning to the example of Mary, from above, the scene may have a platinum level ranking because of the high impact generated by user interactions. The NFTs relating to Mary's scenes may have a greater value because the scene is a platinum scene.

Another type of rarity may be owner-imposed rarity. For example, an owner of (or rightsholder in) audiovisual content may determine to mint only 24 NFTs for a particular scene even though the scene comprises 750 frames. The owner/rightsholder may then announce and publish (and include as part of information about each of the 24 NFTs), that only 24 NFTs for the particular frame have been minted and will ever be minted, thereby imposing rarity. This may be viewed, from one perspective, as a contract between the owner/rightsholder and all owners of any one of the 24 NFTs.

In one embodiment of owner-imposed rarity the value may be adjusted based on an owner's use. This embodiment may use metrics about how frequently the owner “uses” (watching, sharing, commenting on, and/or referencing) his/her NFT. Based on the “use” metrics, the marketplace can generate the value of the particular NFT based on the initial purchase price, owner use, and NFT market for frames most similar to the particular NFT. For example, if a person purchased an NFT for $500, and views it every day to be uplifted, a sale price of $600 may not be a good value because it ignores the value the person derives from the NFT. Also, based on knowledge about every NFT owner's use (i.e., concurrent owners of NFTs for the same frames, or historical owners of NFTs for the same frame, the marketplace will compute or suggest a fair market value of the NFT to others, or at least for use as a factor in determining fair market value of the NFT.

In one embodiment, rarity, including but not limited to asset/computational rarity, transactional rarity, semantic/essence rarity, owner-imposed rarity, and/or use-based rarity may be used to determine a suggested or estimated value or value range for an NFT.

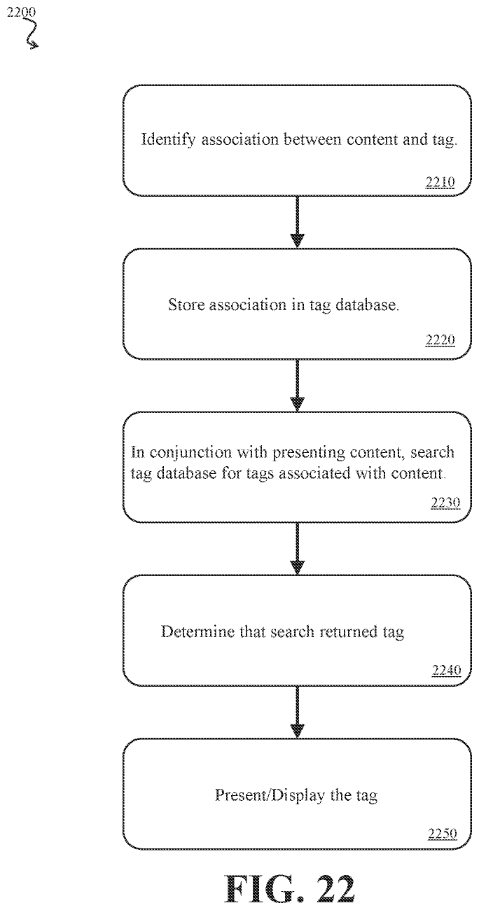

In one embodiment for an exemplary method of implementing rarity, the system disclosed herein (e.g., Video Player 100 and/or associated components) may use one or more of the rarity metrics described herein to determine a value of a NFT, or to suggest a value of an NFT, or for presentation to a user to assist the user in assessing the value and/or other characteristics of an NFT. The rarity metrics disclosed herein may be stored in a database, may be determined dynamically, and/or a combination of such. For example, FIG. 22 illustrates Video Player 100 embodiment with an NFT rarity metric interface 1010. Rarity interface 1010 may include various metric types such as asset rarity 1020a, transactional rarity 1020b, semantic rarity 1020c, owner-imposed rarity 1020d, and owner usage value 1020e. Rarity metrics 1020a-n may be a numerical value, i.e. based on a scale, or the metric may be a word value such as LOW rarity or HIGH rarity.

Notifications/Information to NFT Owner

In one embodiment, viewer/user consumption/usage behaviors and/or patterns for specific content in Video Player 100 usage of an NFT-Centric Viewer may give rise to notifications to an NFT owner or to information that may be provided to an NFT owner.

Notifications to an NFT owner may include, but are not limited to, purchase offers, purchase offers above a reserve price, notification that an auction or listing is ending soon or has ended, transfer/sale of an owned NFT, owner's offer to buy another NFT has been outbid, an offer to buy another NFT has been accepted or has won an auction, context content is trending, and/or a “like”/comment has occurred.

Notification may be provided to the owner of an NFT that context of the frame/excerpt associated with the owned NFT is trending. Context may comprise an associated scene, moment, micro-story, and/or temporally adjacent/proximate audiovisual content. A determination that context is trending may comprise a determination that the context content has received a significant number of likes or other positive feedback, or that the content has been viewed a lot, or that there has been a significant amount of interest in purchasing (e.g., inquiries or purchase offers) an NFT associated with the context content, or any other indication that the context content is popular or has increased or surged in popularity, viewership, and/or desirability.

In some embodiments, e.g., through NFT information interface element 120, a user/viewer may “like,” comment on, share, or otherwise provide feedback or critique on content associated with an NFT, or with context content that is related to the NFT. When or after such “like,” comment, share, or feedback/critique occurs, a notification may be provided to the NFT owner of such. In another embodiment, e.g., through NFT info interface element 120, a user/viewer may comment (“like,” comment, share, provide feedback/critique) directly on an NFT that is associated with content instead of indirectly through the content.

Notifications to NFT Market Participants

An NFT Market Participant may be any person who owns an NFT or who is interested in information about the NFT market and/or potential ownership of one or more NFTs. In one embodiment, an NFT Market Participant may express interest in owning an NFT associated with particular content. An NFT Market Participant may do so by “liking,” indicating interest in owning an NFT, sharing, commenting on, or providing feedback on the specific content. For example, a content viewing interface, which may or may not be similar to the content viewing interface shown in FIG. 1, may include an interface control for allowing a user/viewer to indicate that the user has interest in owning an NFT associated with specific content. In one embodiment, when content playback is paused, an interface may be presented and may include a control for the user to indicate, e.g., “NFT ownership interest for this frame” or “Notify me when NFT becomes available,” or “Notify me of NFT drop,” or “Notify me when NFT is minted.” The interface may additionally provide interface controls for requesting the same or similar notifications without pausing playback of the content. Such notification requests may be for frames, sets of frames, moments, micro-stories, scenes, and any other excerpt from content of identification of content. As shown in FIGS. 2 and 13, a viewer may indicate interest in a scene by interacting with the offer control element 122. In some embodiments, a purchase request may start in an interface which looks like FIG. 2 and then transition into FIG. 13 to make the final offer.

Offer Review Interface

FIG. 12 shows an exemplary Offer Review Interface, which may present to an NFT owner one or more offers on one or more NFTs that the NFT owner owns. Offer details interface 410 may display details for a specific offer and may present interface controls and/or elements to allow an NFT owner to review additional details about the offer or to act on the offer, e.g., by accepting the offer, rejecting the offer, countering, or otherwise.

Segment-Centric Threading

In one embodiment, a media player may comprise an interface for segment-sensitive threading. Many media platforms offer comment threads associated with media content, e.g., audiovisual content, or graphic arts content, or audio content, or other types of content. But these comment threads are associated with the entirety of the associated media content and are not dependent on or specifically tied to a segment, moment, micro-story, scene, or frame—i.e., an excerpt—from the media content. For example, YouTube provides a “Comments” interface for threaded comments directed generally toward the entire YouTube video with which the comments are posted.

Segment-centric comments, however, are specific to a segment of the content, and may change as playback of content progresses forward, or is reversed, or as the current temporal view position is changed. For example, a media player interface may include an interface for segment-centric threading. This Segment-Centric Threading interface may present comments, likes, or similar or related feedback/critique/response for a specific segment of media content. In one embodiment, the thread(s) may change based on the segment of the media that is currently being played by the media player.

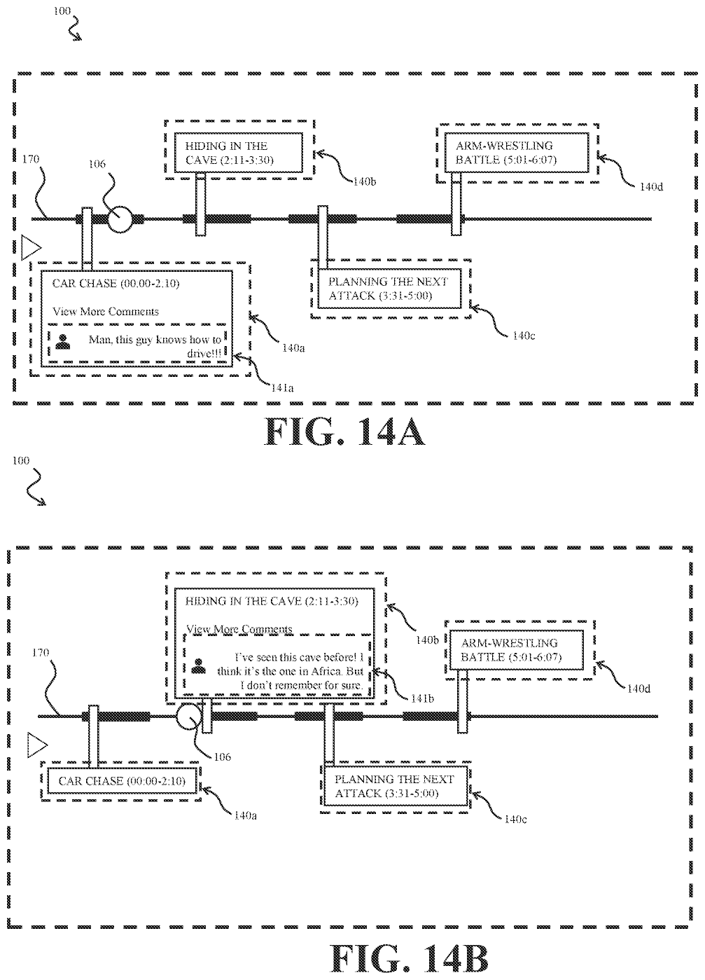

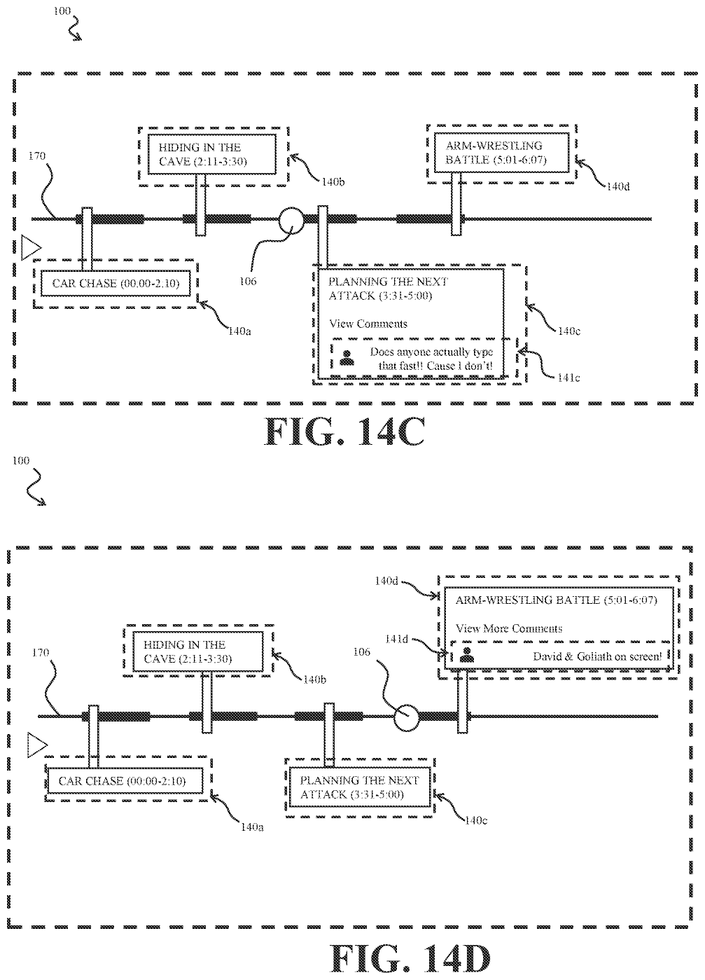

Instead of presenting content metadata, segment-sensitive threading may be presented, see FIGS. 14A-D. For example, four segments may be identified in a piece of audiovisual content: car chase (00:00-2:10); hiding in the cave (2:11-3:30); planning the next attack (3:31-5:00); and the arm-wrestling battle (5:01-6:07). In one embodiment, a new comments thread may be available/presented for each thread. For example, as Video Player 100 is playing the audiovisual content, a supplemental interface may be presented to show comments threads 141a-n that are associated with each respective segment 140a-n. For example, while Video Player 100 is playing the car chase segment from 00:00-2:10, the media player may present a supplemental interface showing a comment thread 141a for the “car chase” segment 140a, see FIG. 14A. When the playback marker 106 reaches time 2:11, when the “hiding in the cave” segment 140b begins, the supplemental interface transitions from presenting the thread for the “car chase” segment to showing the comment thread 141b for the “hiding in the cave” segment, see FIG. 14B. The transition between the segments may be gradual to provide the user/viewer an opportunity to perpetuate the first thread, if desired. At playback marker 106 reaching time 3:31, when the “planning the next attack” segment begins, the supplemental interface transitions from presenting the thread 141b for the “hiding in the cave” segment 140b to showing the thread 141c for the “planning the next attack” segment 140c, see FIG. 14C. At time 5:01, when the “arm wrestling battle” segment 140d begins, the supplemental interface transitions from presenting the thread 141c for the “planning the next attack” segment 140c to showing the thread 141d for the “arm wrestling” segment 140d, see FIG. 14D. In this manner (or in other similar approaches), threads may be maintained and presented for different segments of the same audiovisual content. Such segment-centric threads may include, but are not limited to, comment threads, “liking,” feedback/critique, NFT marketplaces, and/or other segment/excerpt-centric threaded content. In one embodiment, such threads may be updated in real time.

FIGS. 14A-D, illustrate an embodiment of segment threading highlighting a progress bar 170 which is part of the interface 100 and audiovisual content 101. As shown in FIGS. 14A-D, user comments 141a-n are tied to a specific segment, in this embodiment. As a viewer is watching content he can interact with progress bar 170 and playback marker 106 to view comments for one or more segments 140a-n.

In one embodiment, an exemplary method for scene/segment-centric threading (e.g., of comments) may comprise Video Player 100 presenting audiovisual content comprising at least a first scene and a second scene. While playing content from the first scene, Video Player 100 may present a user/viewer comment thread associated with the first scene. While playing content from the second scene, Video Player 100 may present a user/viewer comment thread associated with the second scene. In one embodiment, while Video Player 100 is playing content from the first scene, Video Player 100 may present an interface for adding a comment for the first thread; may receive a comment for the first thread; may store the comment for the first thread; and may display the received comment for the first thread as part of the first thread. In one embodiment, while Video Player 100 is playing content from the second scene, Video Player 100 may present an interface for adding a comment for the second thread; may receive a comment for the second thread; may store the comment for the second thread; and may display the received comment for the second thread as part of the second thread.

Semantic-Centric Threading

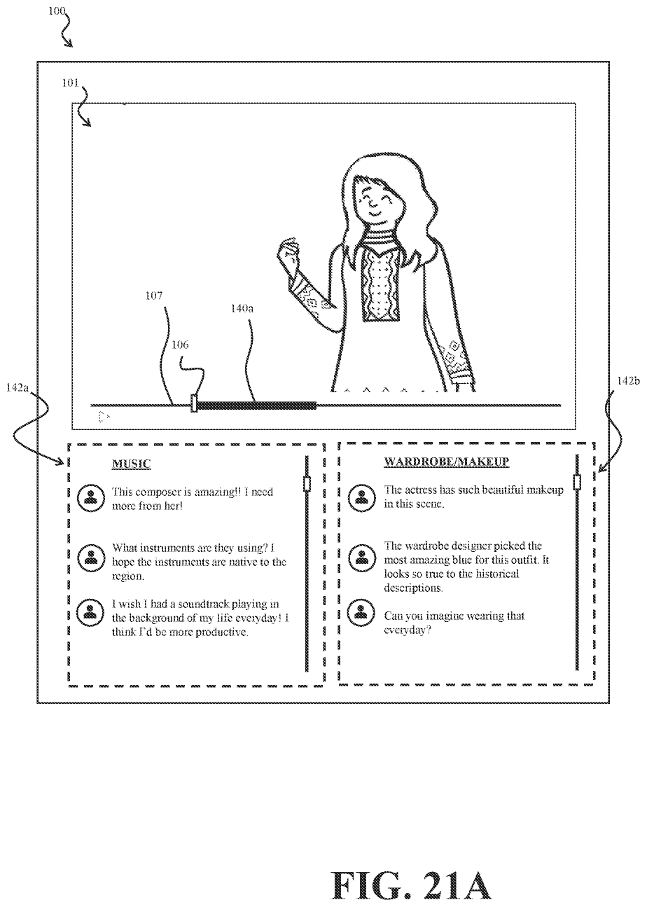

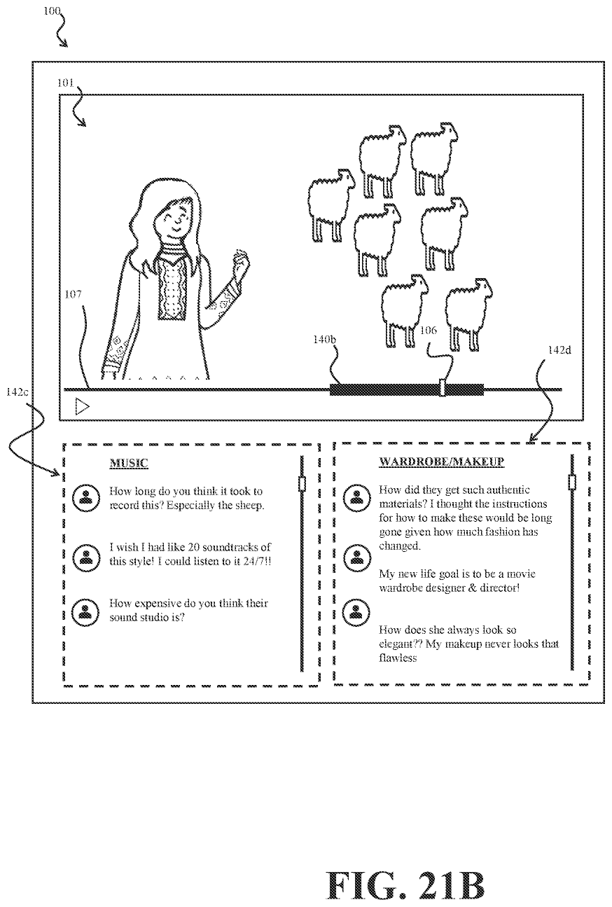

In one embodiment, an exemplary method for semantic threading (e.g., of comments) may comprise Video Player 100, in conjunction with present audiovisual content, present a first thread of user/viewer input 142a relating to the content, wherein the first thread is characterized by a first theme, idea, or subject matter. Video Player 100 may additionally, in conjunction with presenting the same content, present a second thread of user/viewer input 142b relating to the content, wherein the second thread is characterized by a second theme, idea, or subject matter. As simultaneously presented by Video Player 100, the first thread may be visually distinct from the second thread, e.g., the first thread may presented to the left of the second thread, or the first thread may be presented above the second thread. FIGS. 21A-B illustrates segment-centric tagging. In FIG. 21A, the first thread 142a is characterized by MUSIC. Video Player 100 also includes a simultaneously displayed second thread 142b characterized as WARDROBE/MAKEUP. In this embodiment, the first thread 142a is presented to the left of second thread 142b. As shown in FIG. 21B, when playback marker 106 reaches a new segment/scene 140b has a first thread 142c and a second thread 142d. While the first and second threads, 142c and 142d respectively, have the same theme as the previous threads the comments presented are only for scene 140b.

In one embodiment, Video Player 100 may present an interface for adding a comment for the first thread: may receive a comment for the first thread; and may present/display the received comment for the first thread as part of the first thread. Video Player 100 may additionally present an interface for adding a comment for the second thread; may receive a comment for the second thread; and may present/display the received comment for the second thread as part of the second thread.

Tagging

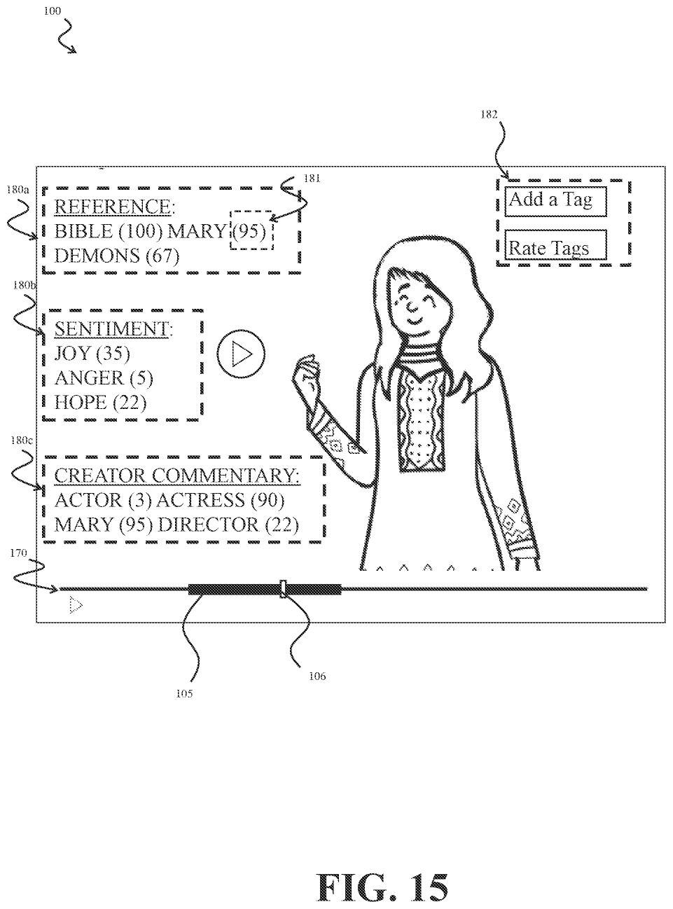

In one embodiment excerpts or segments of content may be tagged. Tagging may be done at multiple temporal levels, e.g., frame, scene, moment, segment, episode, second, minute, hour, etc. From a conceptual perspective, tagging comprises associating content with characterizing information. Such information may include, but is not limited to, emotion (e.g., hope, faith, happiness, resolve, determination, hatred), sentiment, number of actors, action (e.g., violence, punching, kicking, car chase, swordfighting, shooting, kissing, etc.), reference (e.g., a reference to a Bible passage or story, a reference to other literature), location (e.g., location in story, location at which video content was shot), facial expressions, items, product placement, time of day, music (file, artist, song name, etc.), volume, genre, etc. FIG. 15 is an exemplary embodiment of a user interface for tagging for a frame and/or scene. In FIG. 15 there are three groups of tagging 180a-c, REFERENCE, SENTIMENT, and CREATOR COMMENTARY. For each tagging group there are multiple tags with a corresponding rating 181a-n, in this embodiment on the scale of 0-100. The BIBLE REFERENCE tag received a rating of 100 because Mary's story can be found in Luke 8:2 and Mark 16:9. The tag, ANGER SENTIMENT has a ranking of 5 because a viewer felt that ANGER was the proper SENTIMENT for the scene. In one embodiment, viewers are able to add tags or rate the current tags using interface element 182. In one embodiment, every frame may be tagged. In another embodiment, tagging may happen at a scene level. In another embodiments, tagging may happen at any temporal level and/or at a mixture of such temporal levels.

Tagging may be beneficial for many reasons and may be used in many ways. For example, tags may be displayed when content is being played by Video Player 100 and/or when content is paused in Video Player 100. FIG. 15 shows an exemplary embodiment of Video Player 100 in which content playback is paused and tags are visually presented in interface 100.

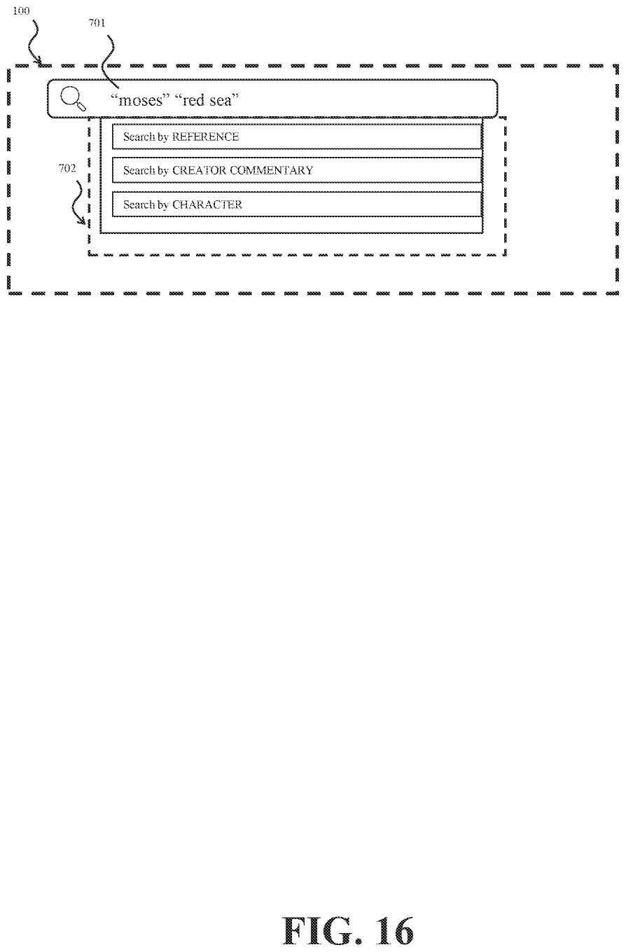

In another embodiment, tagging may facilitate searching. For example, a user may wish to find video content showing the story of Moses parting the Red Sea. Using exemplary interface 100 shown in FIG. 16, the user may enter “moses” and “red sea” for element 701 and select “Search by REFERENCE.” In an alternative embodiment, search option 701 may provide a drop-down list of common or recommended search terms 702 to the user, as shown in FIG. 10. The search terms may be for the audiovisual metadata or tags. An exemplary search would be for Moses and the Red Sea. For this search, a user could start with a REFERENCE search where “BIBLE” has a tag score greater than 85. The results would only include content with a BIBLE REFERENCE score between 86 and 100. In another search, the user may want to see only videos which have been viewed over 2 million times. The search would be “Search by Views (>2 million).” Such tagging may facilitate accurate searching and/or better search results. The tagging information is stored in a database which is dedicated to the tags; the database can index tags based on user input and the content creator's input.

Tags may be added or strengthened through user interaction. The concept of tag “strength” is that a tag is not binary, but may instead have a “strength” or “score.” For example, some tag fields may have a strength score from 1-100, with 100 being the strongest. The tag “faith” may be scored on this scale. Determining a tag strength score may happen in several ways. In one embodiment, a curator/administrator may manually assign a tag score for a particular tag to a scene. In another embodiment, during or after a scene Video Player 100 may present an interface for a user/viewer to enter a tag score or to indicate that a tag should be applied, and Video Player 100 may receive and store responsive input from the user/viewer, see FIG. 15. In another embodiment a tag score may result by accumulating tag input from multiple users, e.g. by applying a statistical or average function to tag input from multiple users. In another embodiment, a tag strength may be determined based in part on the number of times content has been viewed.

An exemplary embodiment of a method for tagging content may comprise identifying an association between content and an idea and content; storing the association; and in conjunction with presenting the content through an interface on an electronic device, presenting the association. The content may be digital content, audiovisual content, or another type of content. In one embodiment, the content may be a sub-segment from a show or episode. In one embodiment, the content is a frame from audiovisual content.

In one embodiment, tagging associations as described herein may be stored in a database such that a tagging record comprises identification of content, identification of a sub-segment of such content, and a tag identifier.

The association may comprise identification of the idea, identification of the content, and identification of a time period from the content for which the association is applicable.

The idea may be at least one from: sentiment, emotion, concept, and reference. In one embodiment, the idea may be a reference to a story and/or book.

In one embodiment, identifying an association between content and an idea comprises receiving input about such association through a user interface on an electronic device.

In one embodiment, the idea may be a concept and may be at least one from: faith, hope, strength, perseverance, honor, love, evil, forgiveness, selfishness, lust, and kindness.

The exemplary method for tagging content may further comprise presenting a search interface configured for searching a library of content by at least one idea search term; receiving an input idea search term; searching a database comprising at least the association; determining that the association matches the idea search term; and presenting a representation of the association as a search result.

FIG. 22 shows an exemplary flowchart 2200 for semantic tagging. At step 2210, Video Player 100 may identify an association between content and a tag. At step 2220, Video Player 100 may store the association in a tag database. At step 2230, Video Player 100 may, in conjunction with presenting the content, search the rag database for tags associated with the content. At step 2240, Video Player 100 may determine that the search returned a tag. At step 2250, Video Player 100 may present/display the tag.

Impact

In one embodiment, Video Player 100 may present a textual or graphical representation of the impact of a user's donation/contribution/participation has had on other users. This impact may arise out of financial donations or support, but could also arise out of other metrics and/or factors, e.g., comments, curating, community activities, user-generated content, etc. The description herein below focuses on impact from a user's financial donations/support, which could be pure donations, investment, or any other type of financial support.

In one embodiment, some or all financial support from a user may be characterized as a pay-it-forward donation, i.e., a donation to fund or otherwise financially support views by other users/viewers. In general, a pay-it-forward donation is a payment (in money or possibly other currency, e.g., cryptocurrency, etc.) made by a first user toward a second user's future (relative to the time of the payment/contribution/donation) consumption of content. In some embodiments “pay-it-forward” may be broadly construed to include a first user's payment toward a second user's consumption of content regardless of the timing of the second party's consumption of content relative to the time at which the pay-it-forward payment was made. In general, the term “pay-it-forward” refers to a first user paying for something for a second user, often for something the second user will consume in the future.

The cost of creating and distributing content may be paid, tracked, and/or accounted for in whole or in part under a pay-it-forward paradigm. In a pay-it-forward paradigm the content may be provided to some or all users (“beneficiary user(s)”) for no cost, and the actual cost of creating and distributing may be borne in whole or in part by a benefactor user (or possibly benefactor users). For example, a benefactor user may be another user who has consumed the content and has determined to pay it forward by making a donation/payment for one or more others (beneficiary users) to consume the content.

In one embodiment, a content producer/distributor may determine that the cost of creating and distributing content is $1.00 per view. Any benefactor user or other benefactor who makes a pay-it-forward payment/donation may be understood to be financing consumption of the content for the number of beneficiary users that is the result of dividing the amount donated by $1.00. For example, donating $150 would fund 150 views (e.g., streaming) of the content. Many variants on this scheme could be implemented. For example, a user/benefactor could partially fund other views, e.g., at 50%, so that a donation of $150 would pay to subsidize 50% of 300 views.

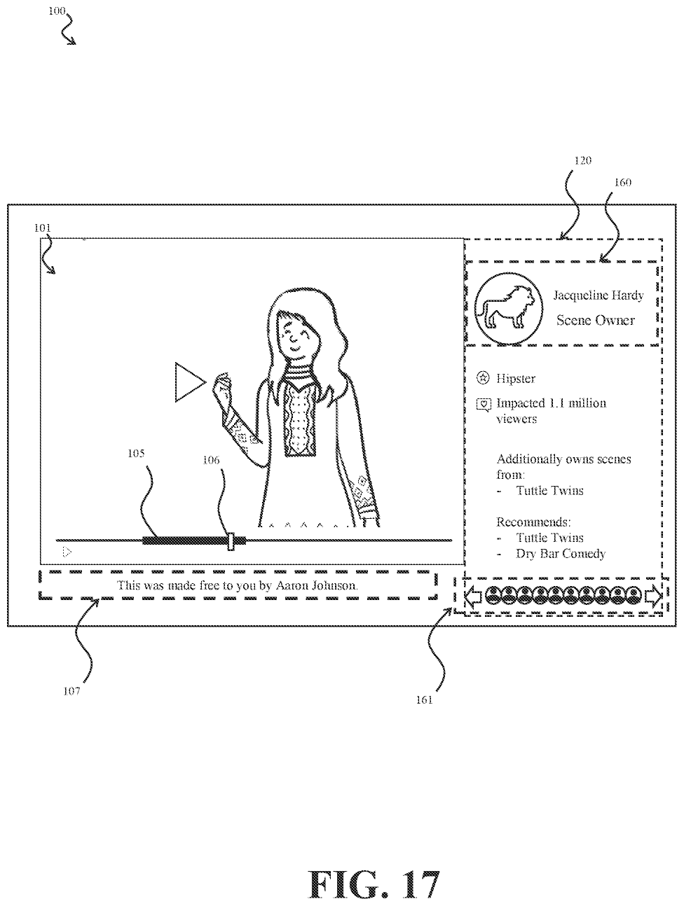

In one embodiment, when a beneficiary-user interacts with an interface element to begin or continue consuming content, or otherwise in association with consuming content, Video Player 100 may present an interface element 107 to the user to indicate that “This was made free for you by [benefactor username or identifier],” see FIG. 17. Interface element 107 may present this message, or a similar message, to a beneficiary user at the beginning of, during, at the end of, or otherwise in association with presentation of content to the beneficiary user. In one embodiment, this benefactor notification may be presented to a beneficiary-user after the beneficiary-user has completed consuming the content, or after the beneficiary-user has ceased consuming the content, for example by text message, email, push notification, app, or messaging service/platform, or other means of communication.

In one embodiment, user interface 100 may present to a pay-if-forward benefactor user a report about, summary of, or visualization of the scope of the benefactor's influence. In one example, a pay-it-forward server may store data reflecting benefactor-beneficiary associations. A benefactor-beneficiary association may comprise a benefactor identifier, a beneficiary identifier, a content identifier, a date (or time period), a benefit description, and a donation identifier. A content identifier may be identification of the content for which the benefactor provided a benefit to the beneficiary. The date (or time period) may be the date on which the beneficiary consumed, or began consuming, or finished consuming, the content identified by the content identifier. The benefit description may be “paid for,” or “partially subsidized,” or “partially subsidized in [amount],” or some other description of the manner in which the benefactor allowed, or helped to allow, the beneficiary to consume the content referenced by the content identifier. The donation identifier may identify a specific donation made by the benefactor, for example a donation of a specific amount made on an earlier date as distinguished from a donation made by the same benefactor on a later date.

Many data storage schemes may be devised to store information about associations between benefactor user payments/contributions and content consumption by beneficiary users. Said data storage schemes may be physical hard drives and/or a virtual cloud server. In one embodiment, the data storage scheme is a hybrid of cloud storage and physical storage. A benefit to this type of data scheme is an extra layer of data protection for users.

The data stored in the pay-it-forward server may be presented in many different ways, for example: (1) the number of beneficiaries that were able to consume specific content thanks to a benefactor's specific donation; (2) the number of beneficiaries who were able to consume specific content over all (or more than one) of the benefactor's donations; (3) the number of beneficiaries who were able to consume any content thanks to a benefactor's specific donation; (4) the number of beneficiaries who were able to consume any content thanks to all (or more than one) of the benefactor's donations; (5) for any of the previous examples, or for any other examples, the identities of some or all of the beneficiaries who were able to consume content thanks to the benefactor; (6) summary characteristics of beneficiaries, e.g., age, geographic location, other demographic characteristics, donation-activity history (e.g., was the beneficiary previously a pay-it-forward benefactor? has the beneficiary since become a pay-it-forward benefactor? have the beneficiary's pay-it-forward donations increased?), content consumption history (e.g., first-time consumer of specific content or of a specific show/series or of a specific type/genre of content?).

In one embodiment, as shown in FIG. 5, a graphical representation 900 of data stored in the pay-it-forward server may comprise a geographic map showing one or more locations 901a-n of a pay-it-forward benefactor's beneficiaries, e.g., a world map showing locations of beneficiaries. This may be referred to as an “impact world map” or a “world impact map.” In one example, world map 900 may have stars of various sizes across the world. For example, as shown in FIG. 5, large star 901a may indicate that a large number of users in a in the location represented by large star 901a have been impacted by a benefactor. Smaller star 901b may indicate that a smaller number of users in a in the location represented by smaller star 901b have been impacted by the benefactor. In some embodiments the world impact map may be presented as a heat map. Geographies other than the entire world may also be used for a geographic impact map. Other graphical representations may be presented to a user to summarize or represent data stored in the pay-it-forward server.

In some embodiments the presentation of pay-it-forward data may be limited to direct impact, i.e., beneficiaries who consumed content paid for by the benefactor. In other embodiments, the presentation of pay-it-forward data may include and/or reflect some measure of indirect impact. For example, the user interface may report, or provide a graphical interface that reflects, individuals or users whose consumption of content has been financed, in whole or in part, by multi-level indirection beneficiaries. For example, a level-2-indirection beneficiary relationship may indicate that the beneficiary's benefactor was himself/herself a beneficiary of an original benefactor. Indirect beneficiary relationships may have any number of levels of indirection, or may be limited, e.g., one level of indirection (“level-2-indirection beneficiary”), or two levels of indirection (“level-3-indirection beneficiary”), or three levels of indirection (“level-4-indirection beneficiary”), etc. All of the representations described above can be modified, altered, or adapted to reflect and/or incorporate indirect beneficiary relationships. In one embodiment, the system may present to a user interface elements for the user to select the number of levels of indirection to be displayed or otherwise represented for pay-it-forward benefactor influence.

As shown in FIG. 6, an indirect or multi-level impact interface may be presented in a tree format 950 similar to a family tree, showing impact at branch and node levels, and may allow the user to expand nodes or to zoom/expand into different areas of the tree interface to review details of multi-level/indirect benefactor-beneficiary relationships. FIG. 6 illustrates a first donor 951 whose pay-it-forward benefited second-level donors 952a and 952b. Second-level donors 952a and 953b then went on to pay-it-forward for the third-level donors 953a-d, respectively. First donor 951 is able to view and explore the tree interface to review details of multi-level/indirect benefactor-beneficiary relationships from his pay-it-forward impact data.

In some embodiments, an entire “page” or “tab” or “window” may be devoted, or principally devoted, to apprising a pay-it-forward user of his/her impact and/or influence resulting from his/her one or more pay-it-forward donations.

In one embodiment, a pay-it-forward benefactor may receive one or more emails (or other types of communications) comprising aggregations or summaries of multiple thank you notes or other communications from pay-it-forward beneficiaries.

In one embodiment, an exemplary method for an impact may comprise the system identifying a condition, event, and/or circumstance that could give rise to user-user impact. This may be a pay-it-forward, donation, financial contribution, or user interaction/promotion/participation comprising, e.g., sharing or contributing comments or user-generated content. The system may associate (e.g., in a database or real-time determination), the contribution event (e.g., pay-it-forward) with a second user's consumption of content. For example, if a first user contributes a $100 pay-it-forward for episode one of season one of a show, and it has been determined that the cost per view/stream of this episode is $1, then the system may determine 100 associations between the first user's pay-it-forward and streaming of the same episode by other users. For example, the system may assign one of the 100 views funded by the $100 pay-it-forward to a second user who subsequently streams the episode. The system may make and store a similar association for all 100 views funded by the first user's $100 pay-it-forward. Additionally, the second user may contribute a pay-it-forward for the same episode (e.g., at the time the second user views/consumes the second episode), and the system may similarly assign the second user's pay-it-forward to one or more subsequent streams/views funded by the second user.

A database may store associations between a first user's pay-it-forward contribution (or another type of contribution) and a second user's viewing of content. In one embodiment, a record in such database may comprise an identification of a contributing user, identification of a contribution (e.g., a pay-it-forward), identification of content with which the pay-it-forward is associated, and identification of a receiving user. Such database may also include timestamps for contribution and streaming events.

In one embodiment, the system (e.g., Video Player 100), may present a text report and/or visualization of the impact a donation or contribution, e.g., a pay-it-forward, had. For example, the visualization may show a map with locations of user views associated with the pay-it-forward. This map may be limited to direct impact, or may additionally include one or more levels of indirect impact, e.g., a third user's view funded by a second user's pay-it-forward, where the second user's view was funded by the first user's pay-it-forward. The visualization may alternatively comprise a tree similar to a genealogy tree. Other impact visualizations may be used and/or presented.

Content Partitioning in Non-Time Dimensions

Although the examples in the disclosure herein focus on content excerpts that are time-delineated (e.g., a temporal moment, a time-delineated excerpt, a frame representing a moment in time, a micro-story, a time-delineated scene, etc.), the disclosure herein applies analogously to dimensions other than time, and to content excerpts that represent excerpts delineated in whole or in part by other dimensions. For example, in addition to time, content excerpts may be delineated by space (i.e., spatially), audio, haptic/touch, smell, and/or other dimensions or effects associated with content.

Additionally, the boundaries in each delineation dimension are not necessarily hard boundaries. For example, a content excerpt may begin and/or end with, or include in the middle, blurred video, or partially blurred video, or video that gradually blurs or unblurs. Similarly, a content excerpt may begin and/or end with, or include in the middle, blurred audio, or partially blurred audio, or audio that gradually blurs or unblurs. Spatial and other dimensions may similarly be delineated by blurring effects, which may analogously be applied to each dimension. Delineation effects may include, but are not limited to, blurring, tapering, transitioning, and/or tailing off.

Additionally, delineation/boundary effects from multiple dimensions may be used in combination. For example, the ending of an excerpt may comprise a tapering of the associated audio and video.

Access Control List

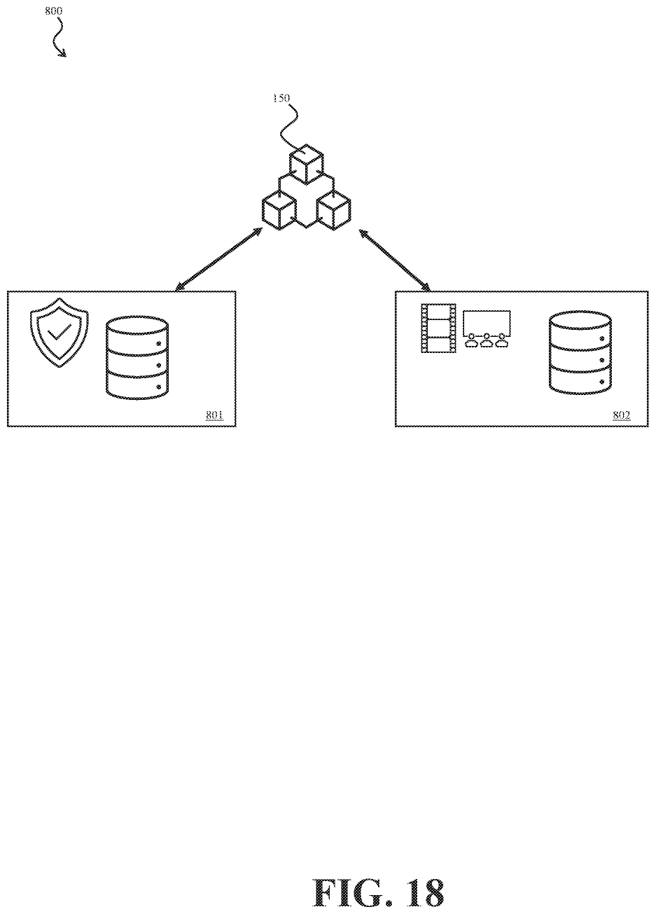

In one embodiment, a blockchain may be use for a universal access control list. For example, a user may own (or otherwise have rights to) an NFT associated with or representing rights to content, e.g., a movie. Using a blockchain-based universal access control list, multiple streaming providers may be able to authoritatively verify the user's rights for the movie. FIG. 18 provides a brief diagram to illustrate this concept. For example, a user may purchase an NFT 150 on streaming platform 1 801 (e.g., YouTube) representing global rights to stream the movie thriller, “Tracking a Three-Legged Squirrel.” When the user logs into streaming platform 2 802 (e.g., Amazon), Amazon may reference the blockchain to verify that the user owns an NFT 150 related to “Tracking a Three-Legged Squirrel,” verify the rights associated with “Tracking a Three-Legged Squirrel,” and then, based on verification that the user does own the NFT 150 and that the NFT 150 does represent global rights to stream “Tracking a Three-Legged Squirrel.” streaming platform 2 802 may provide to the user streaming of “Tracking a Three-Legged Squirrel.”

General

Although the disclosure herein focuses on NF's and blockchains, the innovations described herein may be implemented and/or applied analogously using other technologies for storing, documenting, and verifying transactions (buy, sell, use, license, etc.) of and/or rights in intellectual property, digital assets, and/or tangible assets.

Although much of the disclosure herein refers to a “video player” or “Video Player 100,” such references are not limited to discrete software or hardware, but should be construed broadly to refer also to, according the context in which used, to multiple system components that may comprise software, servers, hardware, firmware, multiple different hardware components, components that are remote from each, etc.

The components described herein may be implemented using numerous technologies known in the art, e.g., software, firmware, hardware, smartphones, laptops, tables, televisions, servers, Internet data transfer, non-Internet data transfer networks, etc. In one exemplary embodiment, Video Player 100 may be software run as an app on a smartphone, or software run on a laptop or other computer, or software run as an app on tablet, or software running on a server, or a combination of such and/or other technology elements. The content and information described herein may be stored in servers and/or databases and may be transferred to user devices or other devices over the Internet or other networks.

What is claimed is:

1. A computer-implemented method for tagging content, comprising:
identifying an association between content and an idea and content;
storing the association; and
in conjunction with presenting the content through an interface on an electronic device, presenting the association.

2. The method of claim 1, wherein the content is digital content.

3. The method of claim 1, wherein the content is audiovisual content.

4. The method of claim 1, wherein the content is a sub-segment from a show or episode.

5. The method of claim 1, wherein the content is a frame from audiovisual content.

6. The method of claim 1, wherein the association comprises identification of the idea, identification of the content, and identification of a time period from the content for which the association is applicable.

7. The method of claim 1, wherein the idea is at least one from: sentiment, emotion, concept, and reference.

8. The method of claim 7, wherein the idea is a reference to a story.

9. The method of claim 7, wherein the idea is a reference to a book.

10. The method of claim 1, wherein identifying an association between content and an idea comprises receiving input about such association through a user interface on an electronic device.

11. The method of claim 1, wherein the idea is a concept.

12. The method of claim 11, wherein the concept is at least one from: faith, hope, strength, perseverance, honor, love, evil, forgiveness, selfishness, lust, and kindness.

13. The method of claim 1, further comprising:
presenting a search interface configured for searching a library of content by at least one idea search term;
receiving an input idea search term;
searching a database comprising at least the association;
determining that the association matches the idea search term; and
presenting a representation of the association as a search result.
